(19) United States
(12) Patent Application Publication
(10) Pub. No.: US 2026/0200391 A1
(43) Pub. Date: Jul. 16, 2026

(54) Lift for Raising a Bed or Other Items in a Structure

(71) Applicant: Lippert Components, Inc., Elkhart, IN (US)

(72) Inventors: Richard Briggs, Roy, UT (US); Chad Johnson, Fielding, UT (US)

(21) Appl. No.: 19/449,338

(22) Filed: Jan. 14, 2026

Related U.S. Application Data
(60) Provisional application No. 63/745,142, filed on Jan. 14, 2025.

(51) Int. Cl. B60P 3/39; A47C 17/80; A47C 19/02; A47C 19/20

(52) U.S. Cl. CPC B60P 3/39; A47C 17/80; A47C 19/021; A47C 19/20

(57) ABSTRACT

A lift includes a guide rail structured to be coupled to a wall of a structure in a vertical orientation, a pulley coupled to the guide rail, and a belt extending along the guide rail and wrapping around the pulley. The pulley can be positioned to rotate about an axis parallel to the wall. In some embodiments, a trolley is coupled to the belt and movable along the guide rail. A belt attachment bracket can couple the trolley to the belt and can include a belt clamp coupled to the belt and a housing structured to maintain engagement between the belt clamp and the belt. In some embodiments, a support leg is coupled to a mounting bracket and an activation mechanism is structured to engage the guide rail and cause the support leg to move from a stowed position to a deployed position.

### TECHNICAL FIELD

This relates to lift systems used to raise and lower objects in structures. More particularly, this relates to belt-driven lift systems used to raise and lower furniture and accessories in recreational vehicles, cargo trailers, and similar vehicles.

### BACKGROUND

Recreational vehicles, cargo trailers, and similar structures often have limited interior space. To maximize usable floor space, lift systems have been developed to move furniture such as beds and sofas between lowered positions for use and raised positions for storage.

Conventional lift systems suffer from a number of drawbacks including excessive noise production during operation, maintaining proper engagement of components, and easily moving various components from one configuration to another. It would be beneficial to improve these or other aspects of conventional lift systems.

### GENERAL DESCRIPTION

A lift is configured to raise and lower furniture items such as beds, sofas, and/or other furniture items in structures such as recreational vehicles and/or cargo trailers. The lift includes one or more guide rails structured to be coupled to a wall of the structure in a vertical orientation. One or more trolleys are coupled to each guide rail and are movable along the guide rail in a lengthwise direction. The trolleys are coupled to the furniture items and carry the furniture items between a lowered position for use and a raised position for storage.

In some embodiments, the lift includes a belt-drive system that provides quiet operation. The belt-drive system includes one or more belts extending along each guide rail. The belts can be made of rubber and/or polyurethane. The belts can form endless loops that extend between upper and lower ends of the guide rails. In some embodiments, each belt is supplied as an endless belt. In other embodiments, each belt is supplied with a first end and a second end that are joined together to form the endless loop, for example using the belt attachment bracket described below. Joining the belt ends in this manner allows an effective circumference (and/or tension) of the endless loop to be adjusted during installation by selecting a relative position of the belt ends before clamping. The belts can include belt teeth structured to engage toothed pulleys. An electric motor provides power to drive the belts and move the trolleys along the guide rails.

A pulley assembly is coupled to each guide rail. The pulley assembly includes a pulley housing and a pulley positioned within the pulley housing. The pulley housing can include one or more interior surfaces that guide a flat side of the belt. In addition, in some embodiments the pulley housing defines bearing surfaces that support the pulley for rotation within the pulley housing, such as opposed circular bearing surfaces in the main body and the cover that engage corresponding circular side surfaces of the pulley. In some embodiments, the pulley is a double pulley having two sets of pulley teeth. The pulley can be positioned at a top end of the guide rail. The pulley assembly, including the pulley housing and the pulley, can be made of plastic. For example, the pulley housing and the pulley can be made of molded plastic, such as nylon, acetal, or other suitable polymers. Using plastic components can reduce the overall weight of the lift and provide quieter operation compared to metal components.

In some embodiments, the pulley is positioned to rotate about an axis that is parallel to the wall of the structure. Positioning the pulley to rotate about an axis parallel to the wall can reduce a profile of the lift relative to the wall. This allows a smaller profile guide rail to be used while still providing smooth belt guidance. In some embodiments, the guide rail can be mounted within the wall of the structure so that only a slit is visible in the wall. This provides a streamlined appearance.

The lift can include a belt attachment bracket coupling the trolley to the belt. In some embodiments, the belt attachment bracket also couples the first end of the belt to the second end of the belt to form the endless loop. This allows the size of the belt loop (and corresponding belt tension) to be adjusted during installation and/or service. The belt attachment bracket is positioned to support the trolley as it moves along the guide rail in the lengthwise direction. The belt attachment bracket includes a belt clamp having clamp teeth that mesh with the belt teeth on the belt. The belt attachment bracket also includes a housing coupled to the belt clamp. The housing is structured to maintain engagement between the clamp teeth and the belt teeth to prevent skipping or sliding between the belt clamp and the belt.

The housing can be slidably coupled to the belt clamp. This allows the housing to be slid over the belt clamp during assembly. The housing can be coupled to the belt clamp by fasteners at a bottom end of the housing. The belt clamp includes a bottom end that extends upward and outside of the housing. The bottom end is structured to engage and support the trolley. The belt attachment bracket extends underneath and contacts the trolley. The trolley can include a recess, and the bottom end of the belt clamp can include a corresponding projection that engages the recess to maintain the connection between the belt attachment bracket and the trolley.

Each trolley can include a main body having a cavity, a wall, and a slot in the wall. The wall defines at least part of the cavity and can be an exterior facing wall of the main body. A hanger bracket is positioned in the cavity and extends outward from the main body through the slot in the wall. The hanger bracket is structured to support the furniture item. An insert is positioned in the cavity, and the hanger bracket is positioned between the wall of the main body and the insert. The insert compresses the hanger bracket against the wall when the trolley is positioned in a channel of the guide rail. This can create a sturdy and compact trolley structure.

The main body and the insert are structured to engage an interior surface of the guide rail to guide movement of the trolley along the guide rail. The insert includes a rail-engaging face structured to slide along the guide rail. In some embodiments, the rail-engaging face includes a channel through which a bunk stop positioned on an interior surface of the guide rail can pass as the trolley moves along the guide rail. This allows the trolley to pass by the bunk stop. In other embodiments, the rail-engaging face is structured to engage the bunk stop so that the trolley rests on and is held in a raised position by the bunk stop. The main body can be made of plastic, and the insert can also be made of plastic and/or other suitable materials that allow the trolley to slide smoothly within the guide rail.

The lift can include a support leg coupled to a mounting bracket that is coupled to the trolley. The support leg is structured to move between a stowed position and a deployed position. The support leg is structured to support the furniture item when the furniture item is in the lowered position. An activation mechanism is coupled to the mounting bracket and is structured to engage the guide rail and cause the support leg to move from the stowed position to the deployed position. The activation mechanism can include a trigger stop on the guide rail and a tab on the support leg. The trigger stop engages the tab as the trolley moves downward along the guide rail, causing the support leg to pivot from the stowed position to the deployed position. This provides automatic deployment of the support leg without user intervention. The support leg is structured to retract when the trolley moves upward.

The lift can include multiple guide rails positioned on opposite walls of the structure. Movement of the trolleys on the opposite walls can be synchronized mechanically and/or electronically. In some embodiments, a drive shaft is coupled between belts on adjacent guide rails to synchronize movement of the trolleys. In other embodiments, a first motor is coupled to a first belt on one wall, a second motor is coupled to a second belt on an opposite wall, and an electronic controller is communicatively linked to the first motor and the second motor. The electronic controller is configured to synchronize operation of the first motor and the second motor. The electronic controller can be communicatively linked to the motors via a wired connection and/or a wireless connection. The dual motor configuration allows for independent movement of the belts on each side when needed, such as to level a furniture item that is slightly off-balance.

The guide rail can be made of an aluminum extrusion. The aluminum extrusion can have radiused corners to provide an aesthetically pleasing appearance. The guide rail can include a groove structured to receive a decorative insert. The decorative insert can be coupled to one or more sides of the guide rail and can be configured to customize a color and/or design appearance of the lift to match interior décor of the structure in which the lift is installed.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

The preferred and other embodiments are described in association with the accompanying drawings in which:

FIGS. 1 and 2 are perspective views of one embodiment of a lift used to move one or more beds between a raised position where they are stowed and a lowered position. The lift is shown with the beds in the lowered position.

FIG. 3 is a front view of a pair of lifting assemblies from the lift in FIG. 1.

FIGS. 4 and 5 are perspective views of the pair of lifting assemblies in FIG. 3.

FIG. 6 is an exploded, perspective view of the lifting assemblies in FIG. 3.

FIG. 7 is a perspective view of one embodiment of a lower moving assembly from the lift in FIG. 1. The lower moving assembly is coupled to a belt and includes two trolleys and a mounting bracket.

FIG. 8 is a perspective view of one embodiment of an upper moving assembly from the lift in FIG. 1. The upper moving assembly includes a trolley and a mounting bracket.

FIG. 9 is a perspective view of an upper corner of the lift in FIG. 1 showing in greater detail a cross member and a guide rail coupled to a pulley assembly.

FIG. 10 is an exploded view of the upper corner of the lift in FIG. 9.

FIG. 11 is a right side, perspective view of the pulley assembly from the upper corner of the lift in FIG. 9.

FIG. 12 is an exploded, perspective view of the pulley assembly in FIG. 11. The pulley assembly includes a pulley housing having a main body and a cover, two pulleys, and a drive shaft.

FIG. 13 is a left side, perspective view of the pulley assembly in FIG. 11 showing the opening through which a belt enters the pulley housing.

FIG. 14 is a rear, exploded, perspective view of the pulley assembly in FIG. 11.

FIG. 15 is a perspective view of one embodiment of a pulley assembly positioned at the bottom of the guide rail. The pulley assembly includes a pulley bracket holding a pulley.

FIG. 16 is an exploded, perspective view of the pulley assembly in FIG. 15.

FIG. 17 is a perspective view of a belt attachment bracket coupled to a belt that extends vertically in the guide rail.

FIG. 18 is a side view of the belt attachment bracket in FIG. 17.

FIG. 19 is a perspective view of the belt attachment bracket showing how it engages the underside of a trolley when they are positioned in the guide rail.

FIG. 20 is an exploded, perspective view of the belt attachment bracket in FIG. 17.

FIG. 21 is an exploded, side view of the belt attachment bracket in FIG. 17.

FIG. 22 is a front, perspective view of one embodiment of a trolley that can be positioned in the guide rail of the lift in FIG. 1 to raise and lower the lower bed.

FIG. 23 is a rear, perspective view of the trolley in FIG. 22.

FIG. 24 is a front view of a guide rail from the lift in FIG. 1 showing a bunk stop positioned in and coupled to the rear wall of the channel formed by the guide rail. The position of the bunk stop can be adjusted using the holes shown in the rear wall of the guide rail.

FIG. 25 is a cross-sectional view of one embodiment of a guide rail from the lift in FIG. 1.

FIG. 26 is a cross-sectional view of another embodiment of a guide rail from the lift in FIG. 1 with the trolley shown in FIGS. 22-23 positioned inside. The trolley has a channel through which the bunk stop passes so that the trolley can pass by the bunk stop.

FIG. 27 is a front, exploded, perspective view of the trolley in FIGS. 22-23. The trolley includes a main body, a reinforcement plate, a hanger bracket, and an insert.

FIG. 28 is a rear, exploded, perspective view of the trolley in FIGS. 22-23.

FIG. 29 is a perspective view of a guide rail with one embodiment of a trolley that can be positioned in the guide rail of the lift in FIG. 1 to raise and lower the upper bed.

FIG. 30 is a perspective view of the trolley in FIG. 29 with the guide rail removed. The trolley is shown positioned above and being held by the bunk stop.

FIG. 31 is a cross-sectional view of a guide rail from the lift in FIG. 1 with the trolley shown in FIGS. 29-30 positioned inside. The trolley does not have a channel so it rests on and is held in a raised position by the bunk stop.

FIG. 32 is a front, exploded, perspective view of the trolley in FIGS. 29-30 positioned above the bunk stop. The trolley includes a main body, a reinforcement plate, a hanger bracket, and an insert.

FIG. 33 is a rear, exploded, perspective view of the trolley in FIGS. 29-30 positioned above the bunk stop.

FIG. 34 is a perspective view of another embodiment of a lift used to move one or more beds between a raised position where they are stowed and a lowered position. In this embodiment, the pulley assembly is positioned so that the pulley rotates about an axis that is parallel to a wall to which the lift is attached. Also, each opposing pair of lifting assemblies includes a motor assembly. The beds are not shown in this figure but can be similar to those in FIG. 1.

FIG. 35 is a perspective view of one pair of lifting assemblies from the lift in FIG. 34.

FIG. 36 is a perspective view of the top of one of the lifting assemblies from the lift in FIG. 34 showing a pulley assembly coupled to the top of a guide rail.

FIG. 37 is a perspective view of the lifting assembly in FIG. 36 with the pulley housing removed to show the belt and pulley inside. The belt runs through channels positioned in the guide rail.

FIG. 38 is a perspective view of the top of the guide rail from the lifting assembly in FIG. 36 with the pulley assembly removed.

FIG. 39 is a perspective view of the bottom of the guide rail in FIG. 38 showing a pulley around which the belt wraps.

FIG. 40 is a cross-sectional view of the top of another embodiment of a guide rail that can be used in the lift in FIG. 34.

FIG. 41 is a perspective view of another embodiment of a lift used to move one or more beds between a raised position where they are stowed and a lowered position. In this embodiment, the pulley assembly also rotates about an axis that is parallel to a wall to which the lift is attached. However, the lifting assemblies and/or guide rails are positioned inside the wall of the structure. Only a slit is visible in the wall.

FIG. 42 is a perspective view of the lift in FIG. 41 with the front surface of the wall removed. The lifting assemblies are shown extending between upper and lower headers in the wall.

FIG. 43 is a perspective view of the top of one of the lifting assemblies from the lift in FIG. 41 showing a pulley assembly coupled at the top of a guide rail.

FIG. 44 is a cross-sectional, perspective view of the lifting assembly in FIG. 43 showing the belt and pulley inside. In this embodiment, the belt runs over two pulleys and a roller.

FIG. 45 is a perspective view of one embodiment of a lift having a support leg that is automatically deployed when it reaches the lowered position. The support leg is shown in the stowed position.

FIG. 46 is a front, perspective view of the lift in FIG. 45 showing the support leg in the deployed position.

FIG. 47 is a rear, perspective view of the lift in FIG. 46.

FIG. 48 shows one embodiment of an electronic computing device that can be used as part of the lift.

FIG. 49 shows various embodiments of the devices that can be included as part of the electronic computing device in FIG. 48.

### DETAILED DESCRIPTION OF EMBODIMENTS

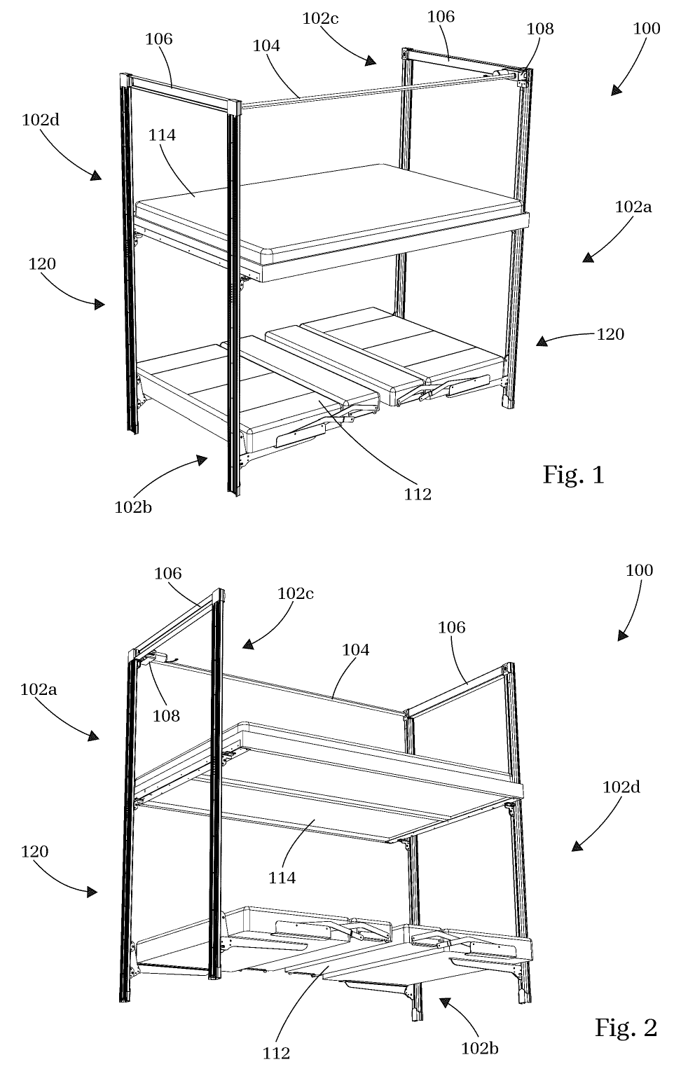

FIGS. 1-2 are perspective views of one embodiment of a lift 100 (alternatively referred to as a lifting system, lifting mechanism, vertical sliding system, or vertical support system) configured to lift a first or lower bed 112 (alternatively referred to as a bunk or berth) and a second or upper bed 114 (alternatively referred to as a bunk or berth) positioned above the lower bed 112. The lift 100 can be positioned in a wide variety of structures including recreational vehicles, cargo trailers, or any of those described in the incorporated documents. The lift 100 can be coupled to the walls of the structure in any of the ways described in the incorporated documents.

The lift 100 includes lifting assemblies 102a, 102b, 102c, 102d (collectively or generically referred to as “lifting assemblies 102” or alternatively referred to as sliding assemblies or sliding mechanisms), a drive shaft 104 (alternatively referred to as a drive member, synchronizing assembly, synchronizing member, or timing assembly), cross members 106, and a motor assembly 108 coupled to the top of the lifting assembly 102a. The lifting assemblies 102a, 102c are configured to be coupled to one side wall of a structure and the lifting assemblies 102b, 102d are configured to be coupled to an opposite facing side wall.

The cross members 106 are coupled between the lifting assemblies 102a, 102c and between the lifting assemblies 102b, 102d, respectively. Each cross member 106 conceals a belt 110 (alternatively referred to as a flexible mechanical drive element) that synchronizes movement of the adjacent lifting assemblies 102a, 102c and the adjacent lifting assemblies 102b, 102d. One of the cross members 106 can be coupled to each pair of lifting assemblies 102a, 102c or 102b, 102d to form a rigid or semi-rigid structure that can be easily coupled to the side wall of the structure.

One of the belts 110 extends from the motor assembly 108 at the top of the lifting assembly 102a to the top of the lifting assembly 102c. The belt 110 synchronizes movement of the pair of lifting assemblies 102a, 102c. Another belt 110 extends from the top of the lifting assembly 102b to the top of the lifting assembly 102d and synchronizes movement of the lifting assemblies 102b, 102d. The motor assembly 108 drives or powers movement of the lifting assemblies 102.

The motor assembly 108 includes an electric motor that provides power to operate the lifting assemblies 102. It should be appreciated that the electric motor can have any suitable structure and/or configuration. For example, in some embodiments, the electric motor is a 12V electric motor that is suitable for use in vehicles such as RVs. In other embodiments, the electric motor can be a different voltage DC motor or an AC motor that is suitable for use in a structure wired with AC power.

The lift 100 in FIGS. 1-2 includes four lifting assemblies 102. However, it should be appreciated that the lift 100 can include any suitable number of lifting assemblies 102 positioned in any suitable configuration. For example, the lift 100 can include one, two, three, or more than four lifting assemblies 102. Likewise, the lifting assemblies 102 can be coupled to only one side wall, opposing side walls, and/or side walls positioned perpendicular to each other. For example, the lift 100 can include two lifting assemblies 102 coupled to the same side wall or one lifting assembly 102 coupled to one side wall and another lifting assembly 102 coupled to another side wall positioned perpendicular to the one side wall.

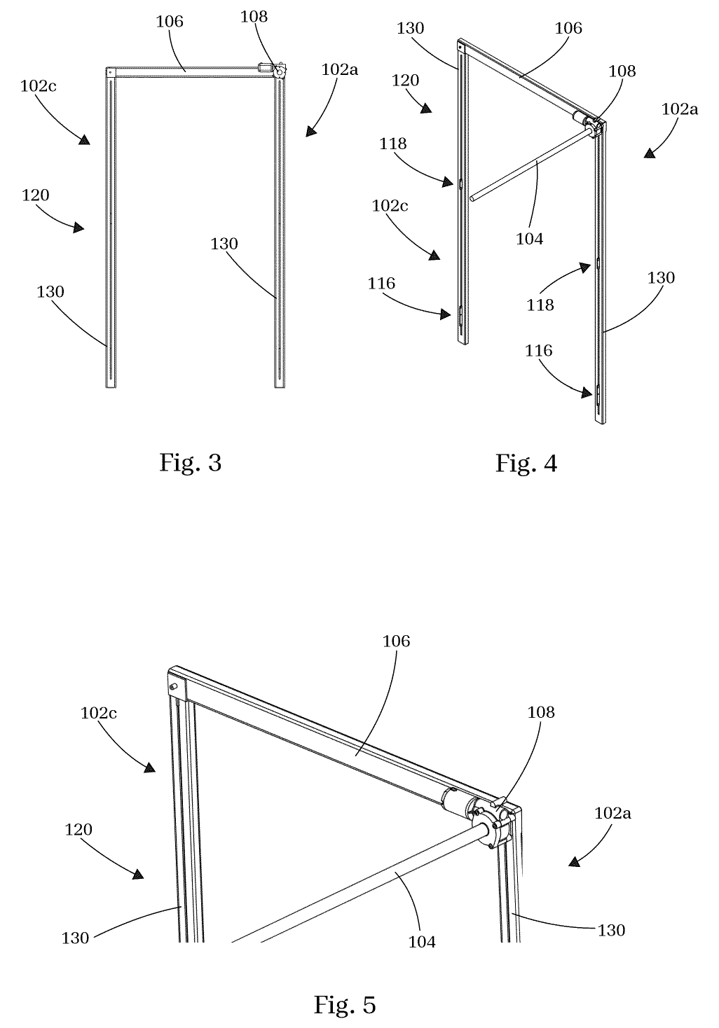

FIGS. 3-5 show the lifting assemblies 102a, 102c coupled to each other with the cross member 106. The lifting assemblies 102b, 102d are a mirror image of the lifting assemblies 102a, 102c and are configured similarly to the lifting assemblies 102a, 102c. The description of the lifting assemblies 102a, 102c applies equally to the lifting assemblies 102b, 102d.

Each lifting assembly 102 includes a lower moving assembly 116 (alternatively referred to as a lower sliding unit or lower moving guide assembly), and a guide assembly 120 (alternatively referred to as a support assembly). The lifting assembly 102 may optionally include an upper moving assembly 118 (alternatively referred to as an upper sliding unit or upper moving guide assembly). The lower moving assembly 116 is coupled to the lower bed 112, and the upper moving assembly 118 is coupled to the upper bed 114. The moving assemblies 116, 118 can be configured to cooperate with the corresponding guide assemblies 120 to raise and lower the beds 112, 114 between the various configurations. For example, the moving assemblies 116, 118 slidably cooperate with the guide assemblies 120 to raise and lower the beds 112, 114.

The lifting assemblies 102 can have a variety of structures and/or configurations including any suitable number of moving assemblies. For example, in some embodiments, each lifting assembly 102 includes a separate moving assembly coupled to each object coupled to the lifting assembly 102. For example, if the lift 100 includes two lifting assemblies 102 and is configured to lift three beds, then each of the two lifting assemblies 102 can include three moving assemblies with each moving assembly being coupled to one of the three beds.

It should be appreciated that the moving assemblies 116, 118 and any other moving assemblies in the lifting assembly 102 can have any suitable design or structure. For example, the moving assemblies in a given lifting assembly 102 can be the same or different. In some embodiments, the lower moving assembly 116 can be configured differently than the upper moving assembly 118. Likewise, if there are three moving assemblies, they can have the same structure, different structures, or two of them can have the same structure and one can have a different structure.

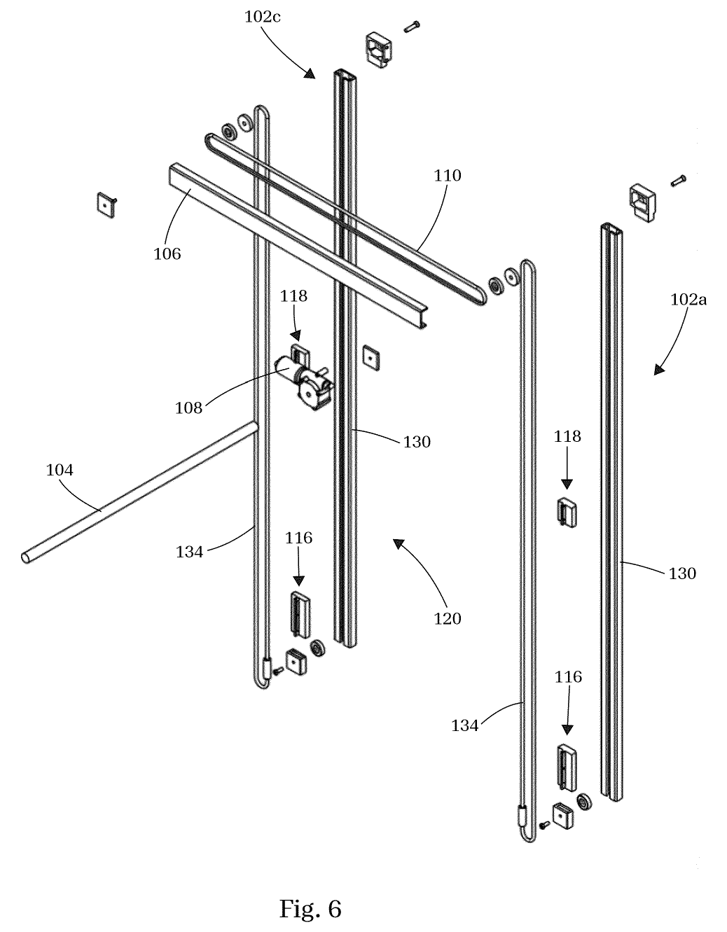

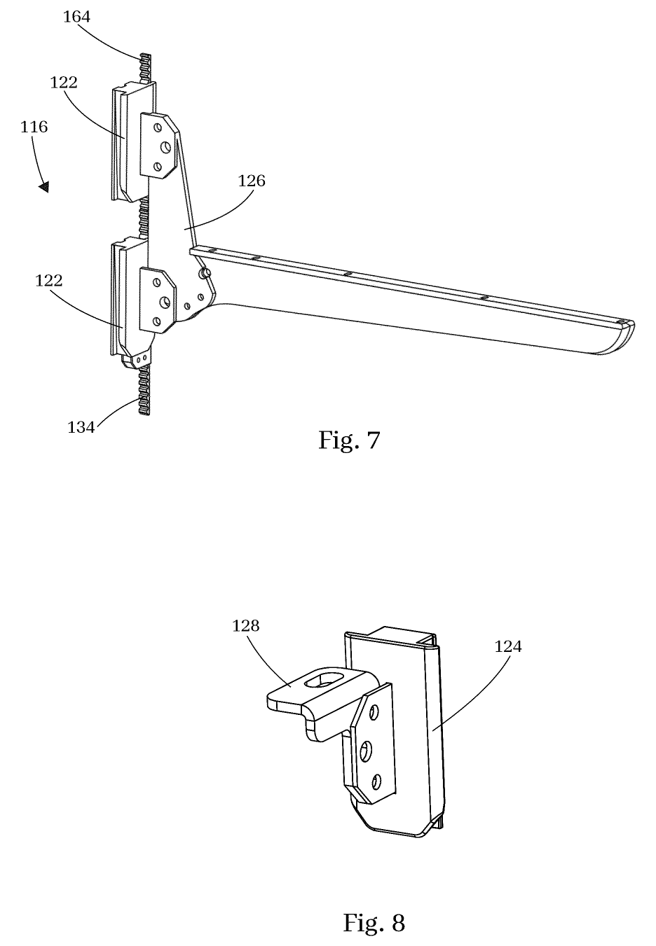

With reference to FIGS. 6-7, each lower moving assembly 116 includes two trolleys 122 (each alternatively referred to as a carriage, moving member, moving guide member, or sliding member) and a mounting bracket 126 coupled to the trolleys 122. The trolleys 122 are coupled to the lower bed 112. Each upper moving assembly 118 includes a trolley 124 (alternatively referred to as a carriage, moving member, housing, moving guide member, or sliding member) coupled to a mounting bracket 128. The trolley 124 is coupled to the upper bed 114.

It should be appreciated that the mounting brackets and trolleys can have any suitable design or structure. For example, they can be structured in the manner shown and described in this document. They can also be structured in any of the ways shown and/or described in the incorporated documents.

With continued reference to FIG. 2, each guide assembly 120 includes a guide rail 130 (alternatively referred to as a guide member, support member, or stanchion) configured to be coupled to one of the side walls of the structure in a vertical orientation. The trolleys 122, 124 are coupled to the guide rail 130 in a manner that allows them to move vertically relative to the guide rail 130. The trolleys 122, 124 cooperate with the guide rail 130 to move the beds 112, 114 between the lowered position and the raised position. In one embodiment, the guide rail 130 defines a channel 132 sized to slidably receive the trolleys 122, 124. For example, the guide rail 130 can have a C-shaped cross section that forms the channel and slidably receives the trolleys 122, 124.

Each lifting assembly 102 includes a belt 134 (alternatively referred to as a flexible mechanical drive element) used to drive movement of one or more of the trolleys 122, 124 in cooperation with the guide rail 130. The motor assembly 108 provides power to move the belts 134 and the drive shaft 104 so that the lifting assemblies 102 operate in unison to raise or lower the beds 112, 114.

The belts 134 form endless loops in the guide rails 130. In some embodiments, the belt 134 is provided as an open-ended belt having a first end and a second end. The first end and the second end can be joined together to form the endless loop, and in some embodiments the belt attachment bracket 156 is used to join the belt ends. For example, end portions of the belt 134 can be positioned in the belt attachment bracket 156 and clamped at a selected relative position (e.g., at a selected tooth engagement position), thereby adjusting an effective circumference of the endless loop and/or belt tension. The belt 134 in each endless loop travels along an endless path. For example, as shown in FIG. 6, the belt 134 forms an endless loop which extends between an upper and a lower end of the lifting assembly 102. The endless loops formed by the belts 134 are generally oriented vertically in a plane that is parallel to the side walls of the structure. It should be appreciated that the belts 134 can have a variety of structures and/or configurations. For example, the belts 134 can have any of the structures and/or configurations described in the incorporated documents.

The lift 100 moves the lower bed 112 and the upper bed 114 between various configurations. For example, the lift 100 can move the beds 112, 114 between the following configurations: (1) a double bunk configuration (FIG. 1) where the lower bed 112 and the upper bed 114 are in a lowered position and oriented horizontally to receive one or more persons to sleep thereon, (2) a single bunk configuration where the lower bed 112 is in the lowered position and the upper bed 114 is in a raised position, (3) a seating configuration where the lower bed 112 is in the lowered position and forms one or two seating units, each of which has a seat base and a seat back, and the upper bed 114 is in the raised position, (4) a first stowed configuration where the lower bed 112 and the upper bed 114 are in a raised position and oriented horizontally adjacent to a ceiling of the structure, and (5) a second stowed configuration where one or both halves of the lower bed 112 are stowed in an upright position adjacent to the side walls of the structure and the upper bed 114 is in the raised position.

It should be appreciated that the lift 100 can be used to move the beds 112, 114 between other configurations including any of the configurations described in the incorporated documents. It should also be appreciated that the configurations can be modified by removing one of the beds—e.g., the upper bed 114—or by adding additional beds. For example, the seating configuration and the stowed configurations described above can be modified by removing the upper bed 114 so that only the lower bed 112 is present. Likewise, the various configurations can be modified by adding one or more additional beds positioned above the upper bed 114. In this way, a triple bunk configuration can be achieved by lowering all the beds and a single bunk configuration can be achieved by lowering only the lower bed 112 and keeping the other beds in the raised position.

In some embodiments, the lift 100 can reciprocally and at least translationally move the beds 112, 114 between the lowered position and the raised position. Translational movement refers to motion of a body where every point of the body moves in a direction parallel to, and by the same distance as, the motion of every other point of the body.

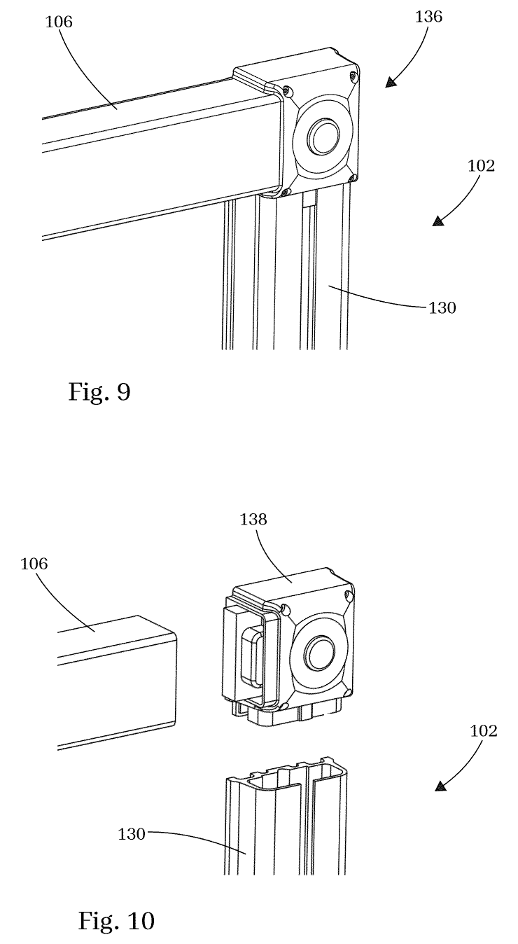

With reference to FIGS. 9-10, each lifting assembly 102 includes a pulley assembly 136 coupled to a top end of the guide rail 130. The pulley assembly 136 guides the belt 134 around the top of the guide rail 130 so that the belt 134 forms the endless loop that extends between the upper and lower ends of the lifting assembly 102. The cross member 106 extends from the pulley assembly 136 to a corresponding pulley assembly 136 on an adjacent lifting assembly 102.

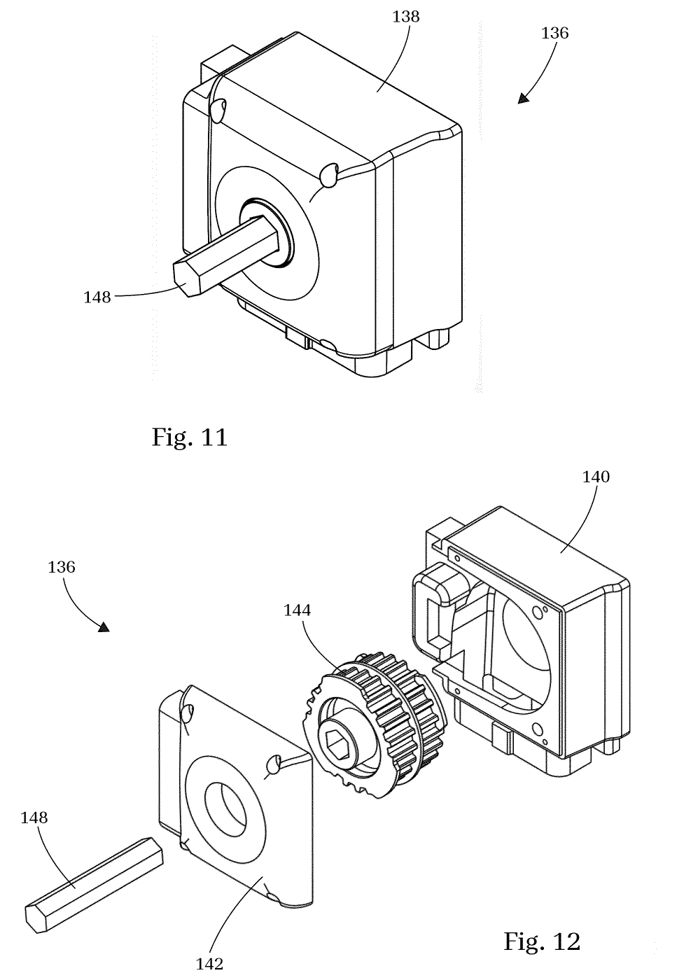

With reference to FIGS. 11-14, the pulley assembly 136 includes a pulley housing 138 and a pulley 144 positioned within the pulley housing 138. The pulley housing 138 includes a main body 140 and a cover 142 coupled to the main body 140. The main body 140 and the cover 142 define an interior space in which the pulley 144 is positioned. In some embodiments, the pulley 144 is a double pulley having two sets of pulley teeth. The pulley teeth are structured to engage belt teeth 164 on the belt 134. In the embodiment shown in FIGS. 11-14, the main body 140 and the cover 142 include respective inward-facing, generally circular bearing surfaces. The pulley 144 includes corresponding circular side surfaces such that opposite sides of the pulley 144 rest on and rotate relative to the bearing surfaces of the main body 140 and the cover 142, thereby supporting and maintaining alignment of the pulley 144 within the pulley housing 138. The pulley housing 138 and the pulley 144 can be made of plastic. Specifically, the main body 140, the cover 142, and the pulley 144 can be formed from injection-molded plastic. This material selection allows the pulley 144 to rotate smoothly within the pulley housing 138 and minimizes wear on the belt 134.

The pulley housing 138 has one or more interior belt-guiding surfaces that guide a flat side of the belt 134. The pulley housing 138 also includes bearing surfaces that support the pulley 144 for rotation, such as opposed circular bearing surfaces on the inward faces of the main body 140 and the cover 142 that contact corresponding circular side surfaces of the pulley 144 (FIGS. 11-14). The pulley 144 is shaped to nest within the pulley housing 138 so that the pulley housing 138 provides a compact structure for guiding the belt 134 around the pulley 144.

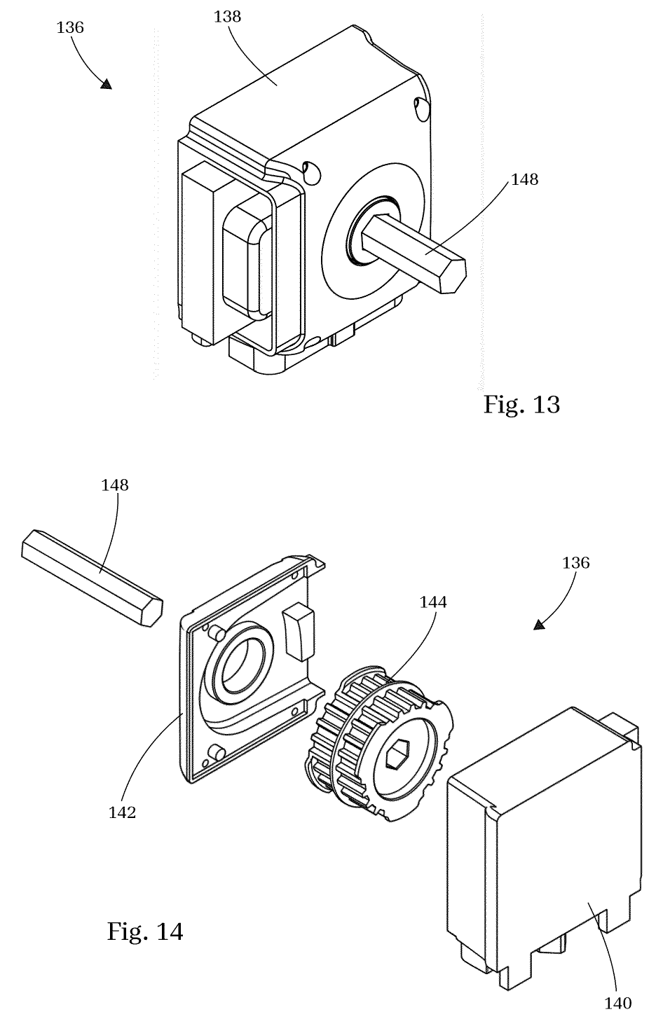

As shown in FIG. 13, the pulley housing 138 includes a side opening through which the belt 110 enters and a bottom opening through which the belt 134 enters. The belts 110, 134 wrap around the pulley 144 and exits through the same opening they entered.

With reference to FIGS. 11-14, the pulley assembly 136 includes a drive shaft 148 coupled to the pulley 144. The drive shaft 148 extends outward from the pulley housing 138 and is structured to couple to the main drive shaft 104 so that the motor assembly 108 can drive rotation of the pulley 144 and move the belts 110, 134.

In the embodiment shown in FIGS. 9-14, the pulley 144 is positioned to rotate about an axis that is perpendicular to the lengthwise direction of the guide rail 130 and perpendicular to the wall of the structure to which the lifting assemblies 102 are coupled. In other words, the axis of rotation of the pulley 144 extends horizontally outward from the side wall of the structure when the guide rail 130 is mounted in a vertical orientation. The drive shaft 148 extends along this axis and couples to the main drive shaft 104.

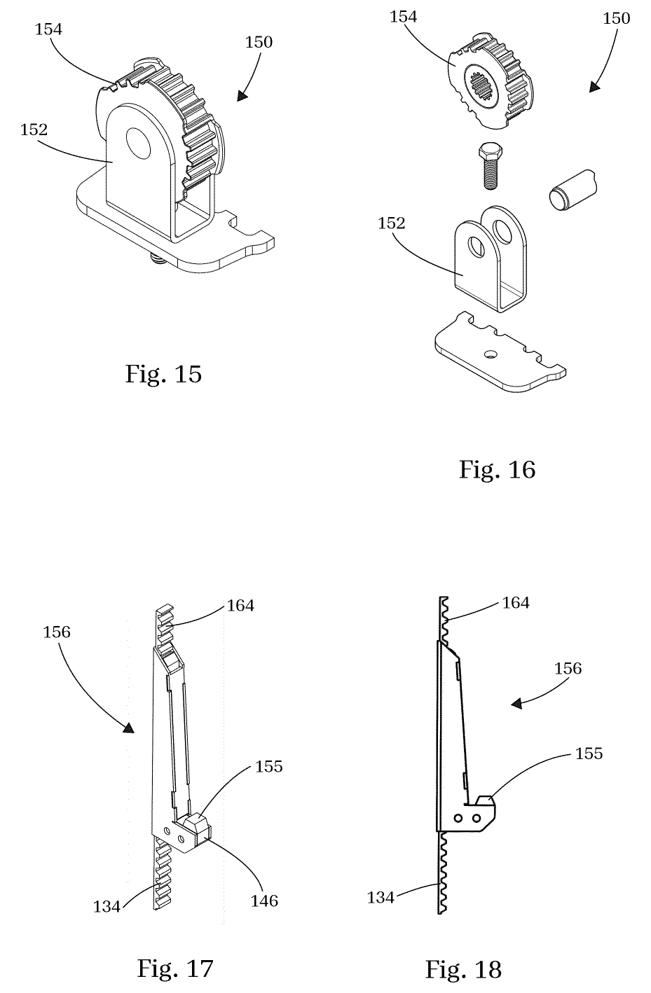

With reference to FIGS. 15-16, each lifting assembly 102 includes a pulley assembly 150 positioned at a bottom end of the guide rail 130. The pulley assembly 150 includes a pulley bracket 152 and a pulley 154 rotatably coupled to the pulley bracket 152. The pulley bracket 152 is structured to couple to the bottom end of the guide rail 130. The belt 134 wraps around the pulley 154 at the bottom of the guide rail 130 and around the pulley 144 at the top of the guide rail 130 to form the endless loop. In embodiments in which the belt 134 is open-ended, the endless loop is completed by coupling the ends together, for example using the belt attachment bracket 156. Like the upper pulley assembly 136, the pulley assembly 150 positioned at the bottom can be made of plastic. For example, the pulley bracket 152 and the pulley 154 can be made of molded plastic.

With reference to FIGS. 17-21, the lift 100 includes a belt attachment bracket 156 coupling one or more of the trolleys 122, 124 to the belt 134. The belt attachment bracket 156 is coupled to the belt 134 and is positioned to support the trolley 122 and/or 124 as it moves along the guide rail 130 in the lengthwise direction. In some embodiments, the belt attachment bracket 156 is positioned at a joint between the first and second ends of the belt 134 and is structured to clamp the belt ends together while also coupling the trolley 122 and/or 124 to the belt 134.

The belt attachment bracket 156 includes a belt clamp 158 having clamp teeth 160 that mesh with the belt teeth 164 on the belt 134. The belt attachment bracket 156 also includes a housing 162 coupled to the belt clamp 158. The housing 162 is structured to maintain engagement between the clamp teeth 160 and the belt teeth 164 to prevent skipping or sliding between the belt clamp 158 and the belt 134. In embodiments in which the belt attachment bracket 156 joins two ends of the belt 134, the belt clamp 158 and housing 162 can clamp respective toothed portions of both belt ends so that the belt ends are secured together without slipping. The belt ends can be secured at different relative positions (e.g., different engaged belt teeth 164) to adjust the loop size.

The housing 162 is slidably coupled to the belt clamp 158. This allows the housing 162 to be slid over the belt clamp 158 during assembly. Once positioned, the housing 162 maintains proper engagement between the clamp teeth 160 and the belt teeth 164 during operation.

With reference to FIGS. 18 and 20-21, the housing 162 is coupled to the belt clamp 158 by fasteners at a bottom end of the housing 162. The belt clamp 158 includes a bottom end 146 that extends upward and outside of the housing 162. The bottom end 146 is structured to engage and support the trolley 122 and/or 124.

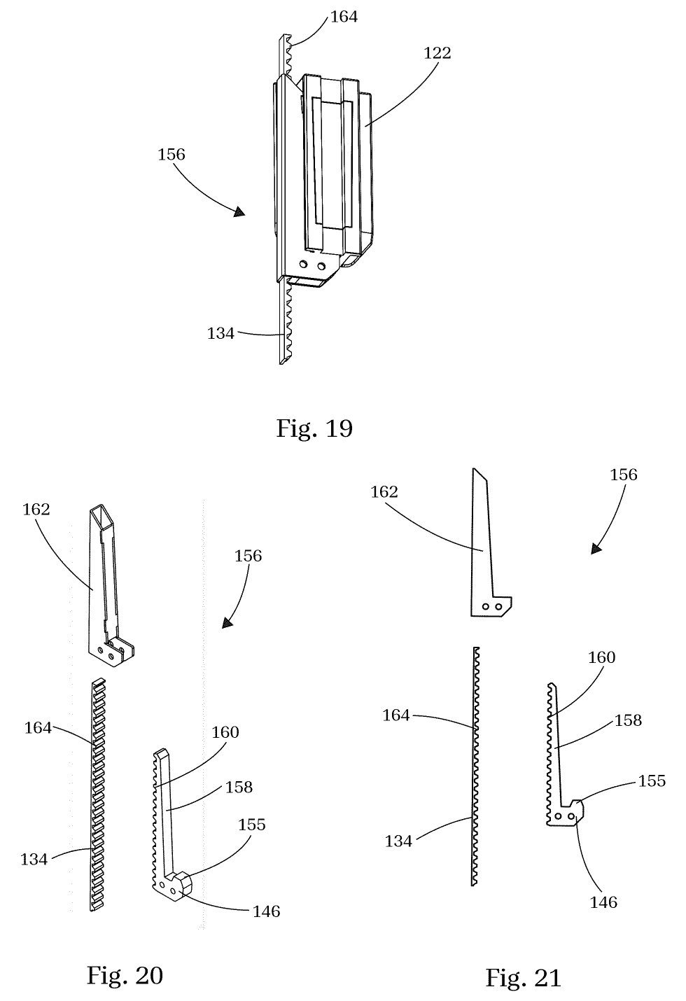

With reference to FIG. 19, the belt attachment bracket 156 extends underneath and contacts the trolley 122 when the trolley 122 is positioned in the guide rail 130. The bottom end 146 of the belt clamp 158 engages the underside of the trolley 122 so that the trolley 122 rests on and is supported by the belt attachment bracket 156. As the belt 134 moves, the belt attachment bracket 156 moves with it and carries the trolley 122 along the guide rail 130.

It should be appreciated that the belt 134 can have a variety of structures and/or configurations. For example, the belt 134 can be made of rubber and/or polyurethane. The use of a rubber and/or polyurethane belt 134 instead of a chain drive provides quieter operation and can contribute to an improved aesthetic appearance of the lift 100.

With reference to FIGS. 25-26, the guide rail 130 can be made of an aluminum extrusion. The aluminum extrusion can have radiused corners to provide an aesthetically pleasing appearance compared to traditional square-cornered channels. The aluminum extrusion forms a channel 132 sized to slidably receive the trolleys 122, 124.

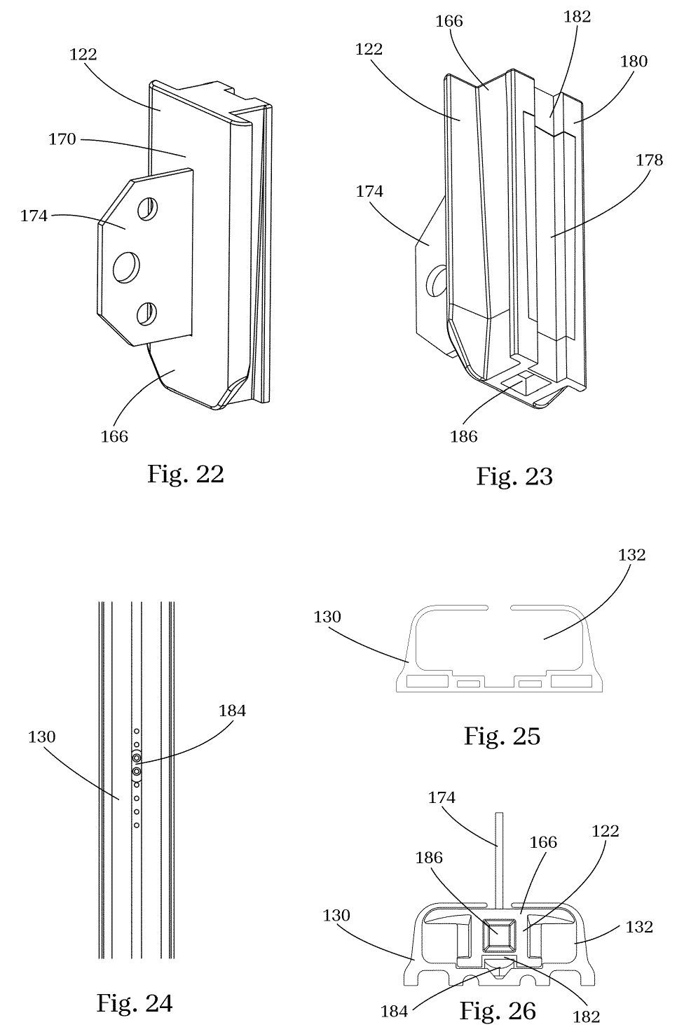

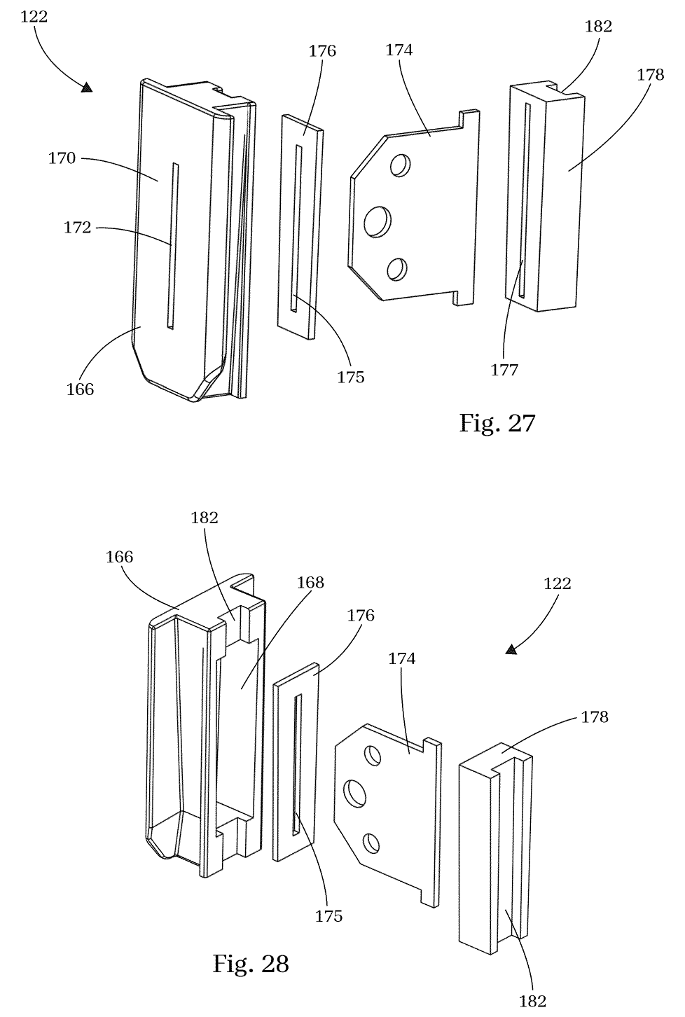

With reference to FIGS. 22-23 and 27-28, each trolley 122 includes a main body 166 having a cavity 168. The main body 166 includes a wall 170 and a slot 172 in the wall 170. The wall 170 defines at least part of the cavity 168. The wall 170 can be an exterior facing wall of the main body 166.

Each trolley 122 includes a hanger bracket 174 positioned in the cavity 168 and extending outward from the main body 166 through the slot 172 in the wall 170. The hanger bracket 174 is structured to support a furniture item such as the lower bed 112, a sofa, a countertop, and/or a kitchenette. The hanger bracket 174 can be coupled to the mounting bracket 126, which in turn is coupled to the lower bed 112 or other furniture item.

Each trolley 122 includes an insert 178 positioned in the cavity 168. The hanger bracket 174 is positioned between the wall 170 of the main body 166 and the insert 178. The insert 178 includes a slot 177 that receives the back of the hanger bracket 174. The insert 178 compresses the hanger bracket 174 against the wall 170 when the trolley 122 is positioned in the channel 132 of the guide rail 130. This creates a sturdy and compact trolley structure.

Each trolley 122 can also include a reinforcement plate 176 positioned in the cavity 168. The reinforcement plate includes a slot 175 that corresponds to the slot 172. The hanger bracket 174 can extend through the slot 175. The reinforcement plate 176 can be positioned between the hanger bracket 174 and the inside of the wall 170 to provide additional structural support.

The main body 166 and the insert 178 are structured to engage an interior surface of the guide rail 130 to guide movement of the trolley 122 along the guide rail 130. The main body 166 and the insert 178 form a rail-engaging face 180 structured to slide along the guide rail 130. In some embodiments, the main body 166 is made of plastic. The insert 178 can also be made of plastic and/or other suitable materials that allow the trolley 122 to slide smoothly within the guide rail 130. The hanger bracket 174 and the reinforcement plate 176 can be made of metal.

With reference to FIGS. 17-19, 23, and 26, the trolley 122 can include a recess 186 positioned in the underside of the trolley 122. The bottom end 146 of the belt clamp 158 includes a corresponding projection 155 that engages the recess 186 when the belt attachment bracket 156 and trolley 122 are positioned in the guide rail 130. This engagement helps maintain the connection between the belt attachment bracket 156 and the trolley 122.

With reference to FIGS. 24 and 26, the lift 100 can include a bunk stop 184 positioned in and coupled to a rear wall of the channel 132 formed by the guide rail 130. The bunk stop 184 extends into the channel 132 and is used to limit the downward travel of the upper bed 114 and/or hold the upper bed 114 in a raised position. The position of the bunk stop 184 can be adjusted using the holes shown in the rear wall of the guide rail 130.

With reference to FIGS. 23 and 26-28, the rail-engaging face 180 of the insert 178 in each trolley 122 can include a channel 182 through which the bunk stop 184 can pass as the trolley 122 moves along the guide rail 130. The channel 182 allows the trolley 122 to pass by the bunk stop 184 so that the trolley 122 and the lower bed 112 can move to positions below the bunk stop 184.

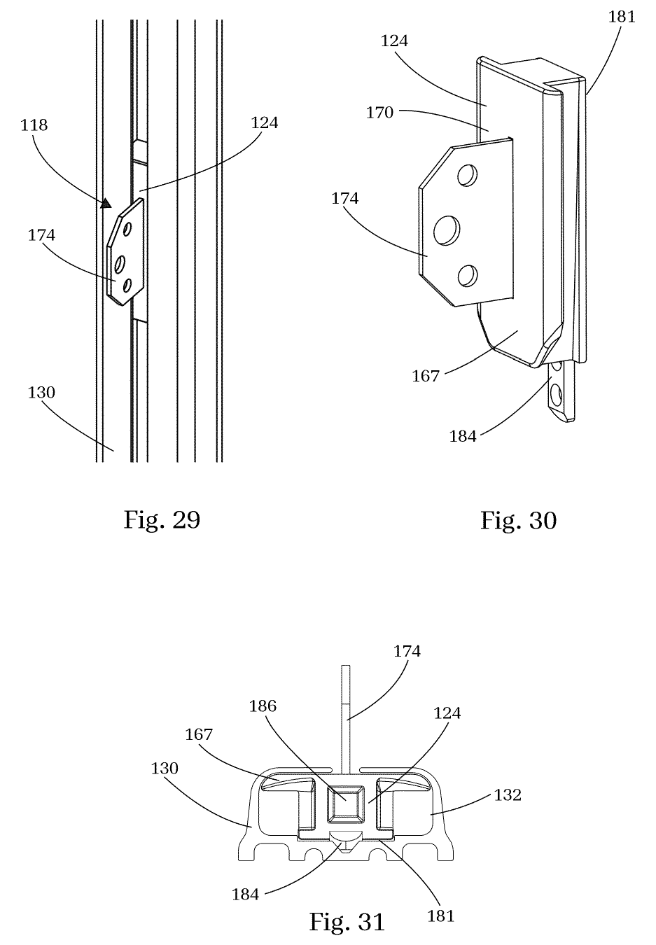

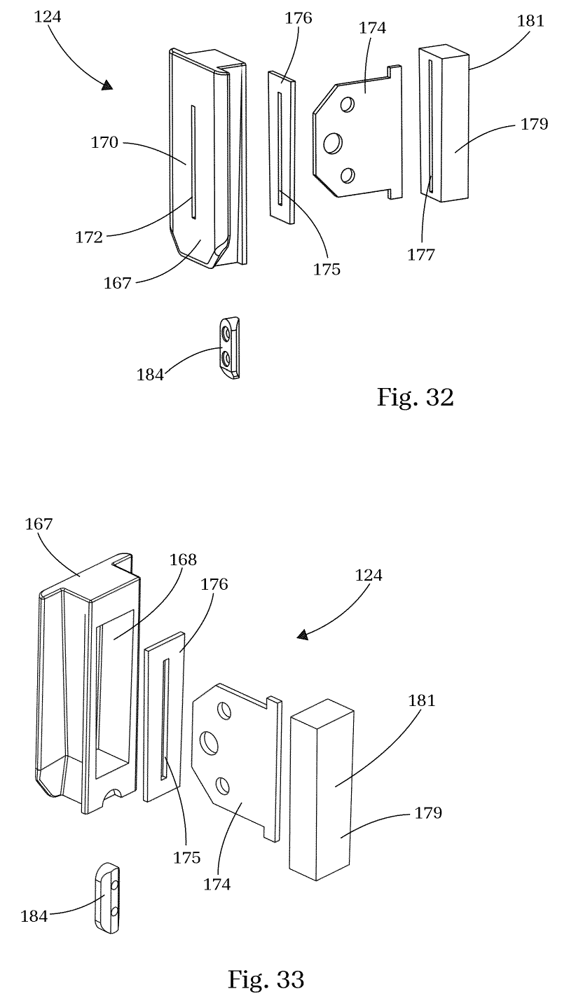

With reference to FIGS. 29-33, each trolley 124 has a structure similar to the trolley 122. Each trolley 124 includes a main body 167 having a cavity 168, a wall 170, and a slot 172 in the wall 170. Each trolley 124 includes a hanger bracket 174 positioned in the cavity 168 and extending outward from the main body 167 through the slot 172. Each trolley 124 includes an insert 179 positioned in the cavity 168, with the hanger bracket 174 positioned between the wall 170 and the insert 179. The hanger bracket 174 extends at least partially into the insert 179.

Each trolley 124 can also include a reinforcement plate 176 positioned in the cavity 168. The insert 179 includes a rail-engaging face 181 structured to slide along the guide rail 130.

With reference to FIGS. 30-31, the rail-engaging face 181 of the insert 179 in each trolley 124 is structured to engage the bunk stop 184 positioned on an interior surface of the guide rail 130 as the trolley 124 moves along the guide rail 130. In other words, the insert 179 of the trolley 124 does not have a channel 182 through which the bunk stop 184 can pass. Instead, the rail-engaging face 181 rests on and is held in a raised position by the bunk stop 184. This allows the upper bed 114 to be held in the raised position while the lower bed 112 is lowered.

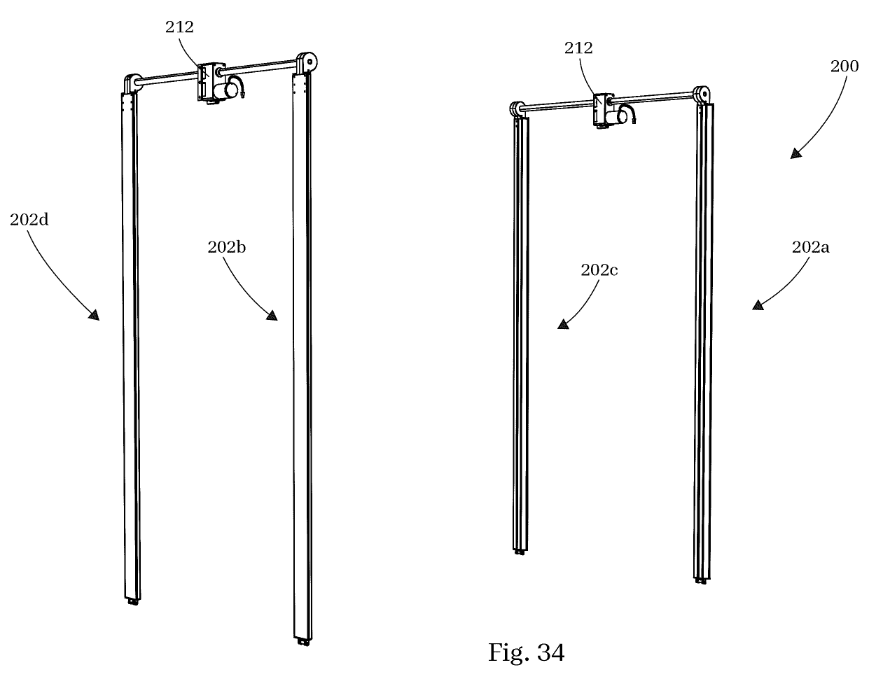

FIGS. 34-40 show another embodiment of a lift 200 configured to move one or more beds between a raised position where they are stowed and a lowered position. In this embodiment, the pulley assembly is positioned so that the pulley rotates about an axis that is parallel to a wall to which the lift 200 is attached. In other words, the axis of rotation of the pulley is perpendicular to the lengthwise direction of the guide rail and is parallel to the surface of the side wall of the structure.

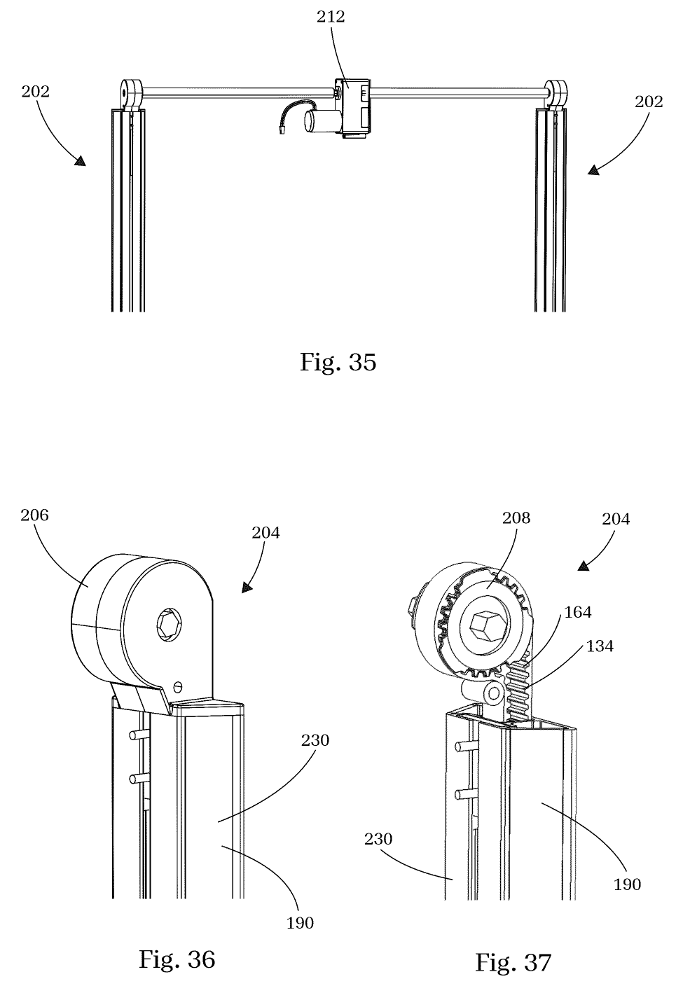

With reference to FIGS. 34-35, the lift 200 includes a pair of lifting assemblies 202a, 202c and a pair of lifting assemblies 202b, 202d similar to those described above (collectively referred to as the lifting assemblies 202). However, in this embodiment, each opposing pair of lifting assemblies 202 includes a motor assembly 212. For example, one motor assembly 212 can be coupled to the lifting assemblies 202a, 202c on one side wall and another motor assembly 212 can be coupled to the lifting assemblies 202b, 202d on an opposite side wall.

With reference to FIGS. 36-37, a pulley assembly 204 is coupled to the top of each guide rail 230. The pulley assembly 204 includes a pulley housing 206 and a pulley 208 positioned within the pulley housing 206. The belt 134 wraps around the pulley 208 and runs through channels positioned in the guide rail.

In this embodiment, positioning the pulley 208 to rotate about an axis that is parallel to the wall reduces a profile of the lift 200 relative to the wall. This allows a smaller profile guide rail to be used on the wall while still providing smooth belt guidance.

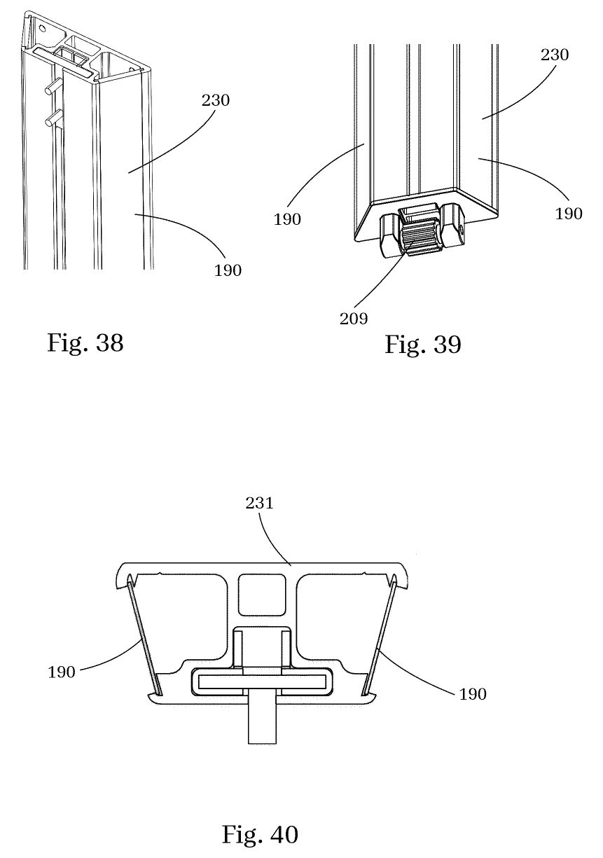

With reference to FIGS. 38-39, the guide rail can include internal channels through which the belt 134 runs. A pulley 209 can be positioned at the bottom of the guide rail around which the belt 134 wraps.

FIG. 40 shows a cross-sectional view of the top of another embodiment of a guide rail 231 that can be used in the lift 200. In the illustrated embodiment, the guide rail includes internal channels and/or cavities that route the belt 134 within the profile of the guide rail.

The guide rails 230, 231 can include one or more grooves structured to receive a decorative insert 190. The decorative insert 190 can be coupled to one or more sides of the guide rails 230, 231. The decorative insert 190 can be configured to customize a color and/or design appearance of the lift 200 to match the interior décor of the structure in which the lift 200 is installed. The decorative insert 190 can be made of plastic and/or other suitable materials. The decorative insert 190 can be provided in various colors and designs. In some embodiments, the decorative insert 190 can be powered—e.g., an LED light strip or cover for LED lights positioned behind the decorative insert 190.

The motor assemblies 212 on opposite side walls can be synchronized electronically to move the belts on the opposite sides in unison, thereby providing balanced lifting and lowering of the attached beds and/or other furniture items. The electronic synchronization of the motor assemblies 212 can be achieved through a wired connection and/or a wireless connection.

In a wired configuration, a cable connects the two motor assemblies 212 together directly so that one controls the other, or connects the two motor assemblies 212 to an electronic controller 101 that coordinates their operation. The cable can be routed through the walls and/or ceiling of the structure to remain hidden from view.

In a wireless configuration, each motor assembly 212 includes a wireless communication module that allows it to receive commands from the electronic controller 101 and/or from the other motor assembly 212 directly. This eliminates the need for routing cables and provides greater flexibility in the placement of the motor assemblies 212.

The electronically synchronized motor assemblies 212 provide an alternative to the mechanically synchronized single motor and drive shaft arrangement described above with reference to FIGS. 1-6. The dual motor configuration allows for independent movement of the belts on each side when needed, such as to level a bed that is slightly off-balance. It also provides redundancy in the event that one of the motor assemblies 212 fails.

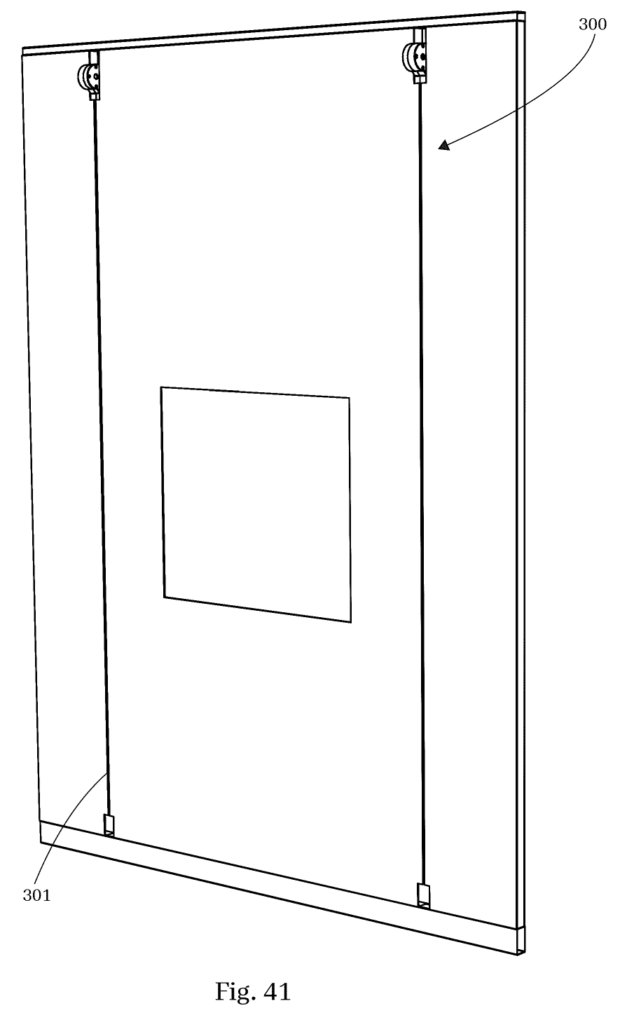

FIGS. 41-44 show another embodiment of a lift 300 in which the lifting assemblies 302 and/or guide rails 330 are positioned inside the wall of the structure. In this embodiment, the guide rails 330 are mounted within the wall and extend between upper and lower headers in the wall. Only a slit 301 is visible in the wall through which the hanger brackets 174 and/or mounting brackets 126, 128 extend.

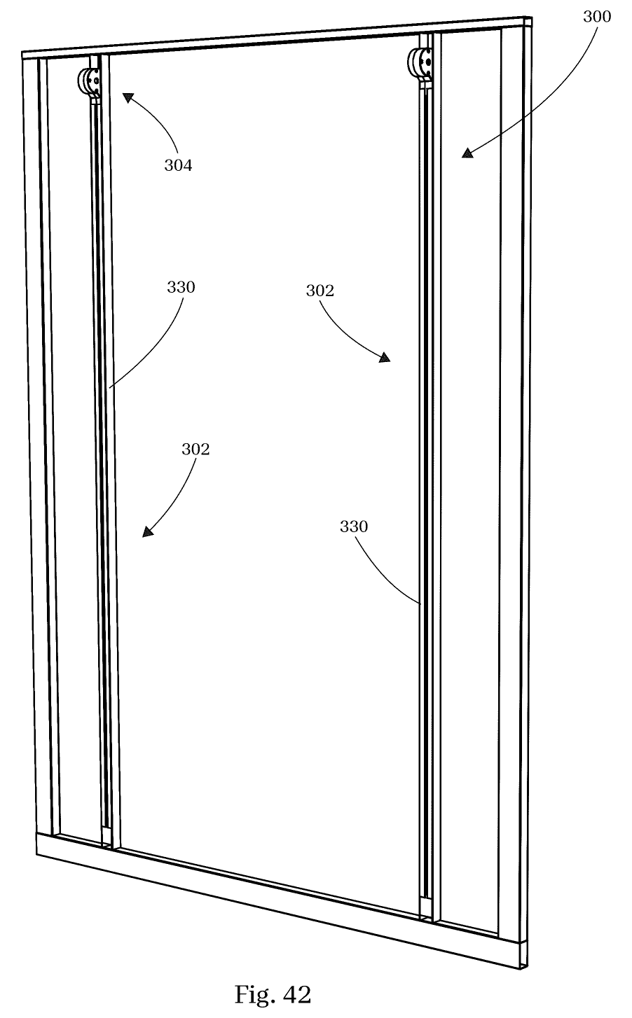

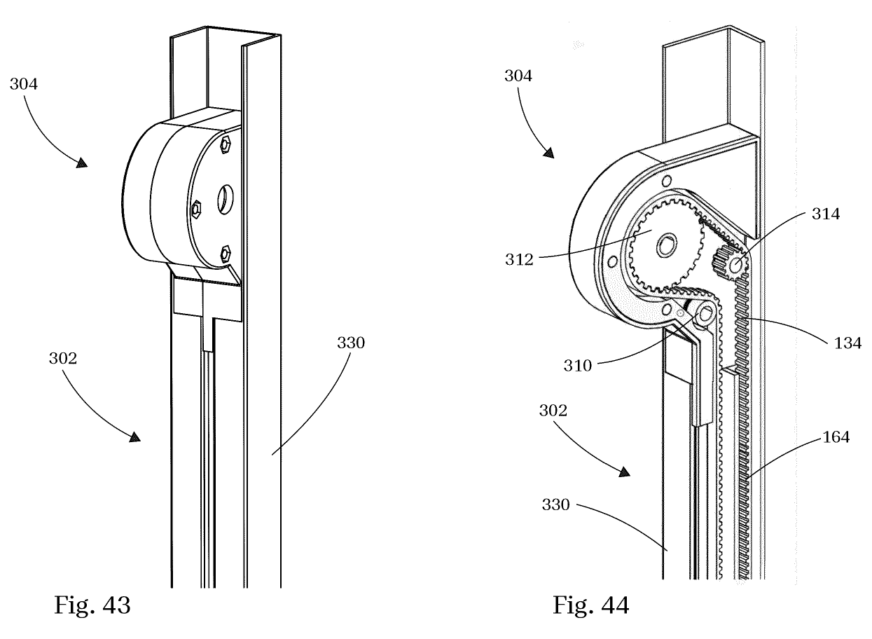

With reference to FIG. 42, the lifting assemblies 302 are shown extending between the upper and lower headers in the wall. The pulley assemblies 304 are coupled at the tops of the guide rails 330.

FIGS. 43-44 show the pulley assembly 304 in greater detail coupled at the top of the guide rail 330. The belt 134 runs over two pulleys 312, 314 and a roller 310. The belt 134 runs through channels in the guide rail 330.

The pulley assemblies 304 in this embodiment are also oriented so that the pulleys rotate about an axis that is parallel to the wall. This reduces the profile of the lifting assemblies 302 and allows them to fit within the wall of the structure.

Mounting the guide rails 330 within the wall provides an even more streamlined appearance. In such configurations, the components that extend out of the wall can be limited to the pulley assemblies 304, the hanger brackets 174, mounting brackets 126, 128, and/or other support components for the beds and/or other furniture items.

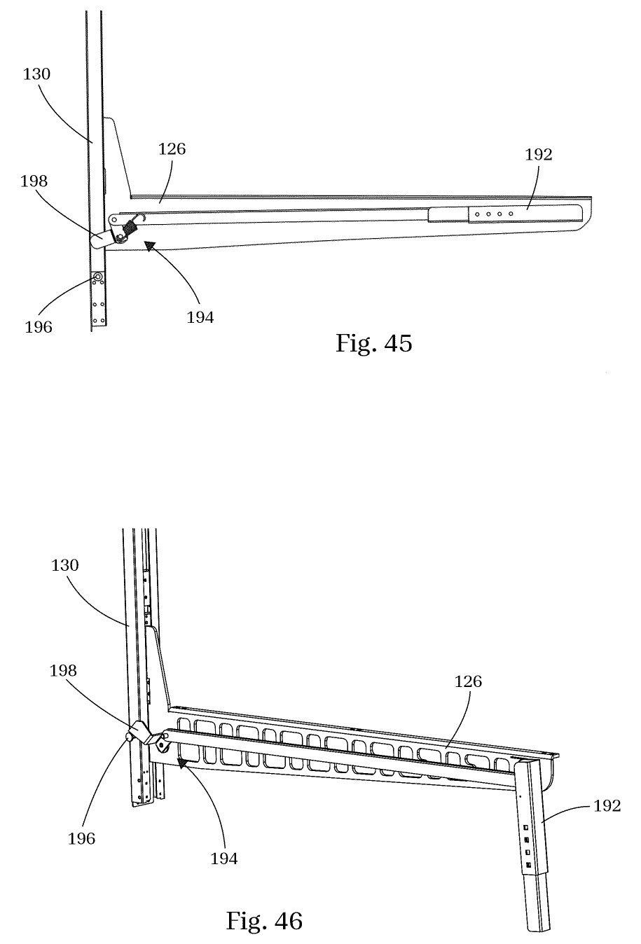

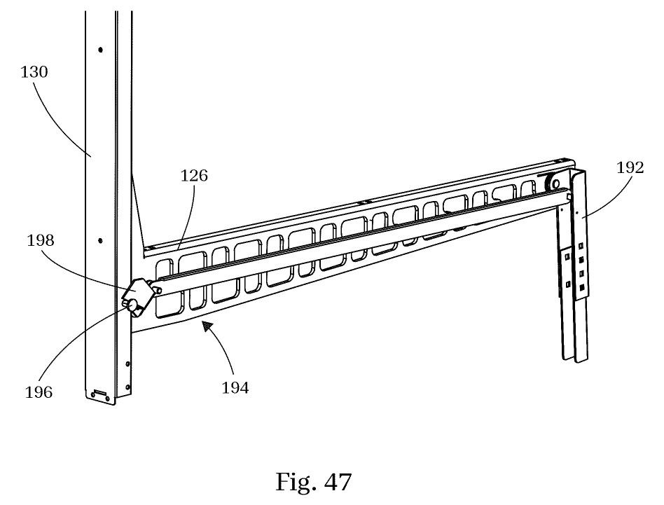

FIGS. 45-47 show another embodiment of the lift 100 comprising a support leg 192 that is automatically deployed when the lower bed 112 and/or other furniture item reaches the lowered position. The support leg 192 is coupled to the hanger bracket 174, the mounting bracket 126, and/or otherwise coupled to the trolley(s) 122. The support leg 192 is structured to move between a stowed position (FIG. 45) and a deployed position (FIGS. 46-47).

The lift 100 includes an activation mechanism 194 structured to engage the guide rail 130 and cause the support leg 192 to move from the stowed position to the deployed position. The activation mechanism 194 includes a trigger stop 196 (e.g., a pin extending outward) on the guide rail 130 and a tab 198. The trigger stop 196 engages the tab 198 as the trolley 122 moves downward along the guide rail 130. The position of the trigger stop 196 on the guide rail 130 can be adjusted to control the height at which the support leg 192 is deployed.

The support leg 192 is pivotably coupled to the mounting bracket 126. As the trolley 122 and the lower bed 112 are lowered, the trigger stop 196 engages and pivots the tab 198, which causes the activation mechanism (a series of linkages) to pivot the support leg 192 from the stowed position to the deployed position. This provides hands-free deployment of the support leg 192 as the lower bed 112 is lowered to the ground.

The automatic deployment of the support leg 192 is useful because users often forget to manually deploy the support leg 192. The support leg 192 is structured to support the furniture item when the furniture item is in the lowered position. The height of the support leg can be telescopically adjusted using holes and corresponding fasteners (holes are shown but not fasteners).

The support leg 192 is structured to retract when the trolley 122 moves upward. For example, as the trolley 122 and the lower bed 112 are raised, a biasing member such as a spring can bias the activation mechanism to pivot the support leg 192 back to the stowed position.

The lifts 100, 200, 300 can be installed in new vehicles during manufacture or retrofitted to existing vehicles. The guide rails can be mounted directly to the walls of the structure using appropriate fasteners. The decorative inserts 190 can be easily snapped into place to provide the desired appearance.

The components of the lift 100, 200 can be manufactured using various materials and processes. The guide rails can be formed by extruding aluminum to create the desired cross-sectional profile with radiused corners. The trolleys 122, 124, the pulley housings 138, 206, and the pulleys 144, 154, 208, 209, 312, 314 can be made from molded plastic and/or metal components. In specific embodiments, the entire pulley assembly (housing and pulley) is made of plastic. The belts 134 can be manufactured from reinforced rubber and/or polyurethane materials with molded and/or cut teeth.

The belt-drive provides several advantages over traditional chain-driven and/or cable-driven systems. The use of belts 134 instead of chains results in quieter operation. The aluminum extrusions with radiused corners and customizable decorative inserts 190 provide improved aesthetics. The compact trolley design with the hanger bracket 174, insert 178, 179, and other components positioned in the cavity 168 of the main body 166, 167 provides reliable operation in a small space. The belt attachment bracket 156 with the belt clamp 158 and housing 162 maintains secure engagement between the trolley 122, 124 and the belt 134 to prevent skipping. The auto-deploy support leg 192 ensures proper support without requiring user intervention.

### Illustrative Embodiments

The following is a description of various embodiments of the disclosed subject matter. Each embodiment can include one or more of the various features, characteristics, or advantages of the disclosed subject matter. The embodiments are intended to illustrate a few aspects of the disclosed subject matter and should not be considered a comprehensive or exhaustive description of all possible embodiments.

P1. A lift comprising: a guide rail having a lengthwise direction, the guide rail being structured to be coupled to a structure in a vertical orientation; and a trolley coupled to the guide rail, the trolley being movable along the guide rail in the lengthwise direction, the trolley comprising: a main body including a cavity, a wall, and a slot in the wall, the wall defining at least part of the cavity; a hanger bracket positioned in the cavity and extending outward from the main body through the slot in the wall; and an insert positioned in the cavity; wherein the hanger bracket is positioned between the wall of the main body and the insert.

P2. The lift of P1 wherein the guide rail comprises an aluminum extrusion.

P3. The lift of P2 wherein the aluminum extrusion has radiused corners.

P4. The lift of any one of P1 to P3 wherein the guide rail comprises a groove structured to receive a decorative insert.

P5. The lift of P4 comprising a decorative insert coupled to a side of the guide rail.

P6. The lift of P5 wherein the decorative insert is configured to customize a color and/or design appearance of the lift.

P7. The lift of any one of P1 to P6 wherein the guide rail comprises a channel and the lift comprises a belt positioned within the channel of the guide rail.

P8. The lift of P7 wherein the belt comprises rubber and/or polyurethane.

P9. The lift of any one of P7 to P8 wherein the belt comprises belt teeth.

P10. The lift of P9 wherein the belt teeth are structured to engage a toothed pulley.

P11. The lift of any one of P7 to P10 wherein the trolley is coupled to the belt.

P12. The lift of any one of P1 to P11 wherein the main body is made of plastic.

P13. The lift of any one of P1 to P12 wherein the wall is an exterior facing wall of the main body.

P14. The lift of any one of P1 to P13 wherein the insert compresses the hanger bracket against the wall.

P15. The lift of any one of P1 to P14 wherein the insert is structured to engage an interior surface of the guide rail to guide movement of the trolley along the guide rail.

P16. The lift of any one of P1 to P15 wherein the insert comprises a rail-engaging face structured to slide along the guide rail.

P17. The lift of P16 wherein the rail-engaging face includes a channel through which a stop positioned on an interior surface of the guide rail can pass as the trolley moves along the guide rail.

P18. The lift of any one of P16 to P17 wherein the rail-engaging face is structured to engage a stop positioned on an interior surface of the guide rail as the trolley moves along the guide rail.

P19. The lift of any one of P1 to P18 wherein the hanger bracket is structured to support a furniture item.

P20. The lift of P19 wherein the furniture item comprises a bed, a sofa, a countertop, and/or a kitchenette.

P21. The lift of any one of P1 to P20 comprising a belt attachment bracket coupling the trolley to a belt.

P22. The lift of P21 wherein the belt comprises belt teeth and wherein the belt attachment bracket comprises: a belt clamp having clamp teeth that mesh with the belt teeth; and a housing coupled to the belt clamp.

P23. The lift of P22 wherein the housing is structured to maintain engagement between the clamp teeth and the belt teeth.

P24. The lift of any one of P22 to P23 wherein the belt clamp comprises a bottom end that extends upward and outside of the housing.

P25. The lift of P24 wherein the trolley comprises a recess and the bottom end engages the recess.

P26. The lift of any one of P22 to P25 comprising fasteners coupling the housing to the belt clamp at a bottom end of the housing.

P27. The lift of any one of P22 to P26 wherein the housing is slidably coupled to the belt clamp.

P28. The lift of any one of P21 to P27 wherein the belt attachment bracket extends underneath and contacts the trolley.

P29. The lift of any one of P1 to P28 comprising a pulley assembly coupled to the guide rail.

P30. The lift of P29 wherein the pulley assembly comprises a pulley housing having an interior surface and a pulley positioned within the pulley housing, and wherein the interior surface guides a flat side of a belt.

P31. The lift of P30 wherein the pulley housing comprises a bearing surface that rotatably supports the pulley within the pulley housing, the bearing surface being defined by the main body and/or the cover and engaging at least one of the opposite side surfaces of the pulley.

P32. The lift of any one of P30 to P31 wherein the pulley comprises a double pulley positioned in the pulley housing.

P33. The lift of any one of P29 to P32 wherein the pulley assembly comprises a pulley positioned to rotate about an axis that is perpendicular to the lengthwise direction of the guide rail.

P34. The lift of any one of P29 to P33 wherein the pulley assembly is positioned at a top end of the guide rail.

P35. The lift of any one of P1 to P34 comprising an electric motor structured to drive a belt coupled to the trolley.

P36. The lift of P35 wherein the electric motor is mounted at a top end of the guide rail.

P37. The lift of any one of P1 to P36 wherein the guide rail is a first guide rail and the trolley is a first trolley, the lift comprising: a second guide rail; and a second trolley coupled to the second guide rail.

P38. The lift of P37 comprising a first belt coupled to the first trolley and a second belt coupled to the second trolley.

P39. The lift of P38 comprising a drive shaft coupled between the first belt and the second belt to synchronize movement of the first trolley and the second trolley.

P40. The lift of any one of P38 to P39 comprising: a first motor coupled to the first belt; a second motor coupled to the second belt; and an electronic controller communicatively linked to the first motor and the second motor and configured to synchronize operation of the first motor and the second motor.

P41. The lift of P40 wherein the electronic controller is communicatively linked to the first motor and the second motor via a wired connection.

P42. The lift of any one of P40 to P41 wherein the electronic controller is communicatively linked to the first motor and the second motor via a wireless connection.

P43. The lift of any one of P1 to P42 wherein the guide rail is mounted within a wall of the structure.

P44. The lift of any one of P1 to P43 wherein the structure comprises a recreational vehicle and/or a cargo trailer.

P45. The lift of any one of P1 to P44 comprising: a support leg coupled to the hanger bracket, the support leg being structured to move between a stowed position and a deployed position; and an activation mechanism structured to engage the guide rail and cause the support leg to move from the stowed position to the deployed position.

P46. The lift of P45 wherein the activation mechanism comprises a trigger stop on the guide rail and a tab on the support leg, and wherein the trigger stop engages the tab as the trolley moves along the guide rail.

P47. A lift comprising: a guide rail having a lengthwise direction, the guide rail being structured to be coupled to a structure in a vertical orientation; a belt coupled to and extending along the guide rail in the lengthwise direction, the belt comprising belt teeth; a trolley coupled to the guide rail, the trolley being movable along the guide rail in the lengthwise direction; and a belt attachment bracket coupled to the belt and positioned to support the trolley as it moves along the guide rail in the lengthwise direction, the belt attachment bracket comprising: a belt clamp having clamp teeth that mesh with the belt teeth; and a housing coupled to the belt clamp and structured to maintain engagement between the clamp teeth and the belt teeth.

P48. The lift of P47 wherein the housing is slidably coupled to the belt clamp.

P49. The lift of any one of P47 to P48 wherein the housing prevents skipping between the belt clamp and the belt.

P50. The lift of any one of P47 to P49 wherein the housing is coupled to the belt clamp by fasteners at a bottom end of the housing.

P51. The lift of any one of P47 to P50 wherein the belt clamp comprises a bottom end that extends upward and outside of the housing.

P52. The lift of P51 wherein the trolley comprises a recess and the bottom end of the belt clamp engages the recess.

P53. The lift of any one of P51 to P52 wherein the bottom end of the belt clamp is structured to support the trolley.

P54. The lift of any one of P47 to P53 wherein the belt attachment bracket extends underneath and contacts the trolley.

P55. The lift of any one of P47 to P54 wherein the guide rail comprises an aluminum extrusion.

P56. The lift of P55 wherein the aluminum extrusion has radiused corners.

P57. The lift of any one of P47 to P56 wherein the guide rail comprises a groove structured to receive a decorative insert.

P58. The lift of any one of P47 to P57 wherein the belt comprises rubber and/or polyurethane.

P59. The lift of any one of P47 to P58 wherein the trolley comprises: a main body including a cavity, a wall, and a slot in the wall; a hanger bracket positioned in the cavity and extending outward from the main body through the slot in the wall; and an insert positioned in the cavity.

P60. The lift of P59 wherein the hanger bracket is positioned between the wall of the main body and the insert.

P61. The lift of any one of P59 to P60 wherein the insert compresses the hanger bracket against the wall.

P62. The lift of any one of P59 to P61 wherein the insert is structured to engage an interior surface of the guide rail.

P63. The lift of any one of P59 to P62 wherein the main body is made of plastic.

P64. The lift of any one of P47 to P63 comprising a pulley assembly coupled to the guide rail, the pulley assembly comprising a pulley housing having an interior surface and a pulley positioned within the pulley housing, wherein the interior surface guides a flat side of the belt.

P65. The lift of P64 wherein the pulley comprises a double pulley positioned in the pulley housing.

P66. The lift of any one of P64 to P65 wherein the pulley is positioned to rotate about an axis that is perpendicular to the lengthwise direction of the guide rail.

P67. The lift of any one of P64 to P66 wherein the interior surface comprises a bearing surface that rotatably supports the pulley within the pulley housing, the bearing surface being defined by the main body and/or the cover and engaging at least one of the opposite side surfaces of the pulley.

P68. The lift of any one of P47 to P67 comprising an electric motor structured to drive the belt.

P69. The lift of any one of P47 to P68 comprising a furniture item supported by the trolley, the furniture item comprising a bed and/or a sofa.

P70. The lift of P69 comprising a support leg coupled to the furniture item, the support leg being structured to move between a stowed position and a deployed position.

P71. The lift of P70 comprising an activation mechanism structured to engage the guide rail and cause the support leg to move from the stowed position to the deployed position.

P72. The lift of P71 wherein the activation mechanism comprises a trigger stop on the guide rail and a tab on the support leg.

P73. The lift of any one of P47 to P72 wherein the structure comprises a recreational vehicle and/or a cargo trailer.

P74. The lift of any one of P47 to P73 wherein the guide rail is a first guide rail, the belt is a first belt, the trolley is a first trolley, and the belt attachment bracket is a first belt attachment bracket, the lift comprising: a second guide rail; a second belt coupled to and extending along the second guide rail; a second trolley coupled to the second guide rail; and a second belt attachment bracket coupled to the second belt and positioned to support the second trolley.

P75. The lift of P74 comprising a drive shaft coupled between the first belt and the second belt to synchronize movement.

P76. The lift of any one of P74 to P75 comprising: a first motor coupled to the first belt; a second motor coupled to the second belt; and an electronic controller communicatively linked to the first motor and the second motor and configured to synchronize operation of the first motor and the second motor.

P77. The lift of P76 wherein the electronic controller is communicatively linked via a wired connection and/or a wireless connection.

P78. A lift comprising: a guide rail having a lengthwise direction, the guide rail being structured to be coupled to a structure in a vertical orientation; a trolley coupled to the guide rail, the trolley being movable along the guide rail in the lengthwise direction; a mounting bracket coupled to the trolley and structured to support a furniture item as the trolley moves along the guide rail in the lengthwise direction; a support leg coupled to the mounting bracket, the support leg being structured to move between a stowed position and a deployed position; and an activation mechanism coupled to the mounting bracket; wherein the activation mechanism is structured to engage the guide rail and cause the support leg to move from the stowed position to the deployed position.

P79. The lift of P78 wherein the activation mechanism comprises a tab coupled to the support leg.

P80. The lift of P79 wherein the tab extends outward from the support leg.

P81. The lift of any one of P79 to P80 wherein the guide rail comprises a trigger stop, and wherein the trigger stop is structured to engage the tab as the trolley moves along the guide rail.

P82. The lift of P81 wherein the trigger stop comprises a trigger pin.

P83. The lift of any one of P81 to P82 wherein the trigger stop is positioned on a side of the guide rail.

P84. The lift of any one of P78 to P83 wherein the support leg is pivotably coupled to the mounting bracket.

P85. The lift of any one of P78 to P84 wherein the support leg is structured to deploy without user intervention.

P86. The lift of any one of P78 to P85 wherein the support leg is structured to support the furniture item when the furniture item is in a lowered position.

P87. The lift of any one of P78 to P86 wherein the support leg is structured to retract when the trolley moves upward.

P88. The lift of any one of P78 to P87 wherein the furniture item comprises a bed and/or a sofa.

P89. The lift of any one of P78 to P88 wherein the guide rail comprises an aluminum extrusion.

P90. The lift of P89 wherein the aluminum extrusion has radiused corners.

P91. The lift of any one of P78 to P90 wherein the guide rail comprises a groove structured to receive a decorative insert.

P92. The lift of any one of P78 to P91 comprising a belt positioned within a channel of the guide rail and coupled to the trolley.

P93. The lift of P92 wherein the belt comprises rubber and/or polyurethane.

P94. The lift of any one of P92 to P93 wherein the belt comprises belt teeth.

P95. The lift of any one of P92 to P94 comprising a belt attachment bracket coupling the trolley to the belt.

P96. The lift of P95 wherein the belt comprises belt teeth and wherein the belt attachment bracket comprises: a belt clamp having clamp teeth that mesh with the belt teeth; and a housing coupled to the belt clamp.

P97. The lift of P96 wherein the housing is structured to maintain engagement between the clamp teeth and the belt teeth.

P98. The lift of any one of P96 to P97 wherein the belt clamp comprises a bottom end that extends upward and outside of the housing and engages the trolley.

P99. The lift of any one of P95 to P98 wherein the belt attachment bracket extends underneath and contacts the trolley.

P100. The lift of any one of P78 to P99 wherein the trolley comprises: a main body including a cavity, a wall, and a slot in the wall; a hanger bracket positioned in the cavity and extending outward from the main body through the slot in the wall; and an insert positioned in the cavity.

P101. The lift of P100 wherein the hanger bracket is positioned between the wall of the main body and the insert.

P102. The lift of any one of P100 to P101 wherein the insert compresses the hanger bracket against the wall.

P103. The lift of any one of P78 to P102 comprising a pulley assembly coupled to the guide rail.

P104. The lift of P103 wherein the pulley assembly comprises a pulley housing having an interior surface structured to guide a flat side of a belt.

P105. The lift of any one of P103 to P104 wherein the pulley assembly comprises a pulley positioned to rotate about an axis that is perpendicular to the lengthwise direction of the guide rail.

P106. The lift of any one of P78 to P105 comprising an electric motor structured to drive a belt coupled to the trolley.

P107. The lift of any one of P78 to P106 wherein the guide rail is a first guide rail, the trolley is a first trolley, and the mounting bracket is a first mounting bracket, the lift comprising: a second guide rail positioned on an opposite side of the furniture item from the first guide rail; a second trolley coupled to the second guide rail; and a second mounting bracket coupled to the second trolley and structured to support the furniture item.

P108. The lift of P107 comprising a first belt coupled to the first trolley and a second belt coupled to the second trolley.

P109. The lift of P108 comprising a drive shaft structured to synchronize movement of the first belt and the second belt.

P110. The lift of any one of P108 to P109 comprising: a first motor coupled to the first belt; a second motor coupled to the second belt; and an electronic controller communicatively linked to the first motor and the second motor and configured to synchronize operation of the first motor and the second motor.

P111. The lift of P110 wherein the electronic controller is communicatively linked via a wired connection and/or a wireless connection.

P112. The lift of any one of P78 to P111 wherein the structure comprises a recreational vehicle and/or a cargo trailer.

P113. The lift of any one of P78 to P112 wherein the guide rail is mounted within a wall of the structure.

P114. A lift comprising: a guide rail having a lengthwise direction, the guide rail being structured to be coupled to a wall of a structure in a vertical orientation; a pulley coupled to the guide rail; and a belt coupled to and extending along the guide rail in the lengthwise direction, the belt wrapping around the pulley; wherein the pulley is positioned to rotate about an axis that is parallel to the wall of the structure.

P115. The lift of P114 wherein the axis is perpendicular to the lengthwise direction of the guide rail.

P116. The lift of any one of P114 to P115 wherein positioning the pulley to rotate about the axis reduces a profile of the lift relative to the wall.

P117. The lift of any one of P114 to P116 comprising a pulley housing, wherein the pulley is positioned within the pulley housing.

P118. The lift of P117 wherein the pulley housing comprises an interior surface that guides a flat side of the belt.

P119. The lift of P118 wherein the interior surface comprises a bearing surface that rotatably supports the pulley within the pulley housing, the bearing surface being defined by the main body and/or the cover and engaging at least one of the opposite side surfaces of the pulley.

P120. The lift of any one of P117 to P119 wherein the pulley comprises a double pulley positioned in the pulley housing.

P121. The lift of any one of P114 to P120 wherein the belt comprises belt teeth and the pulley comprises pulley teeth that engage the belt teeth.

P122. The lift of any one of P114 to P121 wherein the belt comprises rubber and/or polyurethane.

P123. The lift of any one of P114 to P122 wherein the guide rail comprises an aluminum extrusion.

P124. The lift of P123 wherein the aluminum extrusion has radiused corners.

P125. The lift of any one of P114 to P124 wherein the guide rail comprises a groove structured to receive a decorative insert.

P126. The lift of any one of P114 to P125 wherein the pulley is positioned at a top end of the guide rail.

P127. The lift of any one of P114 to P126 comprising a trolley coupled to the guide rail and movable along the guide rail in the lengthwise direction.

P128. The lift of P127 wherein the trolley is coupled to the belt.

P129. The lift of any one of P127 to P128 wherein the trolley comprises: a main body including a cavity, a wall, and a slot in the wall; a hanger bracket positioned in the cavity and extending outward from the main body through the slot in the wall; and an insert positioned in the cavity.

P130. The lift of P129 wherein the hanger bracket is positioned between the wall of the main body and the insert.

P131. The lift of any one of P127 to P130 comprising a belt attachment bracket coupling the trolley to the belt.

P132. The lift of P131 wherein the belt comprises belt teeth and wherein the belt attachment bracket comprises: a belt clamp having clamp teeth that mesh with the belt teeth; and a housing coupled to the belt clamp.

P133. The lift of P132 wherein the housing is structured to maintain engagement between the clamp teeth and the belt teeth.

P134. The lift of any one of P131 to P133 wherein the belt attachment bracket extends underneath and contacts the trolley.

P135. The lift of any one of P114 to P134 comprising an electric motor structured to drive the belt.

P136. The lift of any one of P114 to P135 wherein the guide rail is a first guide rail, the pulley is a first pulley, and the belt is a first belt, the lift comprising: a second guide rail; a second pulley coupled to the second guide rail; and a second belt coupled to and extending along the second guide rail, the second belt wrapping around the second pulley; wherein the second pulley is positioned to rotate about a second axis that is parallel to the wall.

P137. The lift of P136 comprising a drive shaft coupled between the first pulley and the second pulley to synchronize movement of the first belt and the second belt.

P138. The lift of any one of P136 to P137 comprising: a first motor coupled to the first pulley; a second motor coupled to the second pulley; and an electronic controller communicatively linked to the first motor and the second motor and configured to synchronize operation of the first motor and the second motor.

P139. The lift of P138 wherein the electronic controller is communicatively linked via a wired connection.

P140. The lift of any one of P138 to P139 wherein the electronic controller is communicatively linked via a wireless connection.

P141. The lift of any one of P114 to P140 comprising: a trolley coupled to the guide rail; a mounting bracket coupled to the trolley and structured to support a furniture item; a support leg coupled to the mounting bracket, the support leg being structured to move between a stowed position and a deployed position; and an activation mechanism structured to engage the guide rail and cause the support leg to move from the stowed position to the deployed position.

P142. The lift of P141 wherein the activation mechanism comprises a trigger stop on the guide rail and a tab on the support leg.

P143. The lift of any one of P114 to P142 wherein the structure comprises a recreational vehicle and/or a cargo trailer.

P144. The lift of any one of P114 to P143 wherein the guide rail is mounted within the wall of the structure.

P145. A lift comprising: a guide rail having a lengthwise direction, the guide rail being structured to be coupled to a structure in a vertical orientation; a belt coupled to and extending along the guide rail in the lengthwise direction, the belt comprising belt teeth; a trolley coupled to the guide rail, the trolley being movable along the guide rail in the lengthwise direction; and a belt attachment bracket coupled to the belt and positioned to support the trolley as it moves along the guide rail in the lengthwise direction; wherein the belt attachment bracket extends underneath and contacts the trolley.

P146. The lift of P145 wherein the belt attachment bracket comprises: a belt clamp having clamp teeth that mesh with the belt teeth; and a housing coupled to the belt clamp.

P147. The lift of P146 wherein the housing is structured to maintain engagement between the clamp teeth and the belt teeth.

P148. The lift of any one of P146 to P147 wherein the housing is slidably coupled to the belt clamp.

P149. The lift of any one of P146 to P148 wherein the housing is coupled to the belt clamp by fasteners at a bottom end of the housing.

P150. The lift of any one of P146 to P149 wherein the belt clamp comprises a bottom end that extends upward and outside of the housing.

P151. The lift of P150 wherein the bottom end of the belt clamp contacts the trolley.

P152. The lift of any one of P150 to P151 wherein the trolley comprises a recess and the bottom end of the belt clamp engages the recess.

P153. The lift of any one of P145 to P152 wherein the trolley comprises: a main body including a cavity, a wall, and a slot in the wall; a hanger bracket positioned in the cavity and extending outward from the main body through the slot in the wall; and an insert positioned in the cavity.

P154. The lift of P153 wherein the hanger bracket is positioned between the wall of the main body and the insert.

P155. The lift of any one of P153 to P154 wherein the hanger bracket is structured to support a furniture item comprising a bed, a sofa, a countertop, and/or a kitchenette.

P156. The lift of any one of P153 to P155 wherein the insert compresses the hanger bracket against the wall.

P157. The lift of any one of P153 to P156 wherein the insert is structured to engage an interior surface of the guide rail.

P158. The lift of any one of P153 to P157 wherein the main body is made of plastic.

P159. The lift of any one of P145 to P158 wherein the guide rail comprises an aluminum extrusion.

P160. The lift of P159 wherein the aluminum extrusion has radiused corners.

P161. The lift of any one of P145 to P160 wherein the guide rail comprises a groove structured to receive a decorative insert.

P162. The lift of P161 comprising a decorative insert coupled to a side of the guide rail.

P163. The lift of any one of P145 to P162 wherein the belt comprises rubber and/or polyurethane.

P164. The lift of any one of P145 to P163 comprising a pulley assembly coupled to the guide rail, the pulley assembly comprising a pulley housing having an interior surface and a pulley positioned within the pulley housing, wherein the interior surface guides a flat side of the belt.

P165. The lift of P164 wherein the interior surface comprises a bearing surface that rotatably supports the pulley within the pulley housing, the bearing surface being defined by the main body and/or the cover and engaging at least one of the opposite side surfaces of the pulley.

P166. The lift of any one of P164 to P165 wherein the pulley comprises a double pulley positioned in the pulley housing.

P167. The lift of any one of P164 to P166 wherein the pulley is positioned to rotate about an axis that is perpendicular to the lengthwise direction of the guide rail.

P168. The lift of any one of P164 to P167 wherein the pulley is positioned to rotate about an axis that is parallel to a wall of the structure.

P169. The lift of any one of P164 to P168 wherein the pulley assembly is positioned at a top end of the guide rail.

P170. The lift of any one of P145 to P169 comprising an electric motor structured to drive the belt.

P171. The lift of P170 wherein the electric motor is mounted at a top end of the guide rail.

P172. The lift of any one of P145 to P171 comprising: a mounting bracket coupled to the trolley and structured to support a furniture item; a support leg coupled to the mounting bracket, the support leg being structured to move between a stowed position and a deployed position; and an activation mechanism structured to engage the guide rail and cause the support leg to move from the stowed position to the deployed position.

P173. The lift of P172 wherein the activation mechanism comprises a trigger stop on the guide rail and a tab on the support leg.

P174. The lift of any one of P172 to P173 wherein the furniture item comprises a bed and/or a sofa.

P175. The lift of any one of P145 to P174 wherein the guide rail is a first guide rail, the belt is a first belt, the trolley is a first trolley, and the belt attachment bracket is a first belt attachment bracket, the lift comprising: a second guide rail; a second belt coupled to and extending along the second guide rail; a second trolley coupled to the second guide rail; and a second belt attachment bracket coupled to the second belt; wherein the second belt attachment bracket extends underneath and contacts the second trolley.

P176. The lift of P175 comprising a drive shaft coupled between the first belt and the second belt to synchronize movement.

P177. The lift of any one of P175 to P176 comprising: a first motor coupled to the first belt; a second motor coupled to the second belt; and an electronic controller communicatively linked to the first motor and the second motor and configured to synchronize operation of the first motor and the second motor.

P178. The lift of P177 wherein the electronic controller is communicatively linked via a wired connection.

P179. The lift of any one of P177 to P178 wherein the electronic controller is communicatively linked via a wireless connection.

P180. The lift of any one of P145 to P179 wherein the structure comprises a recreational vehicle and/or a cargo trailer.

P181. The lift of any one of P145 to P180 wherein the guide rail is mounted within a wall of the structure.

### Electronic Computing Device

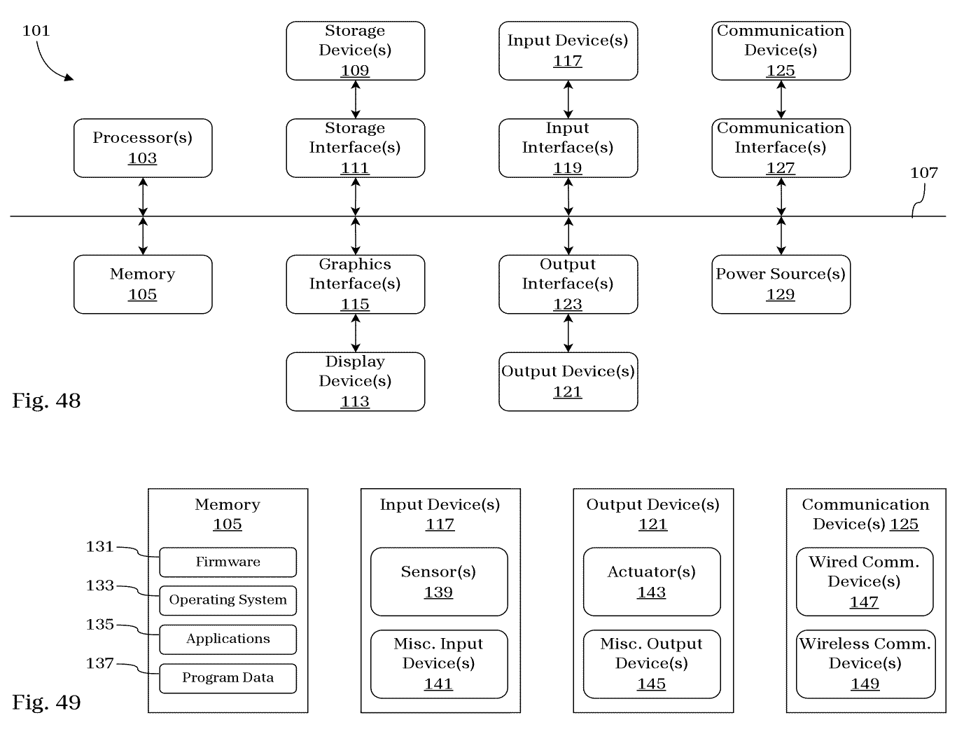

FIG. 48 shows one embodiment of an electronic computing device 101 (alternatively referred to as an electronic controller, programmable logic controller, electronic control system, or electronic computing system) that can be used to control operation of the lift. FIG. 49 shows exemplary subcomponents that can be included as part of the electronic computing device 101.

The electronic computing device 101 includes one or more processors 103 (alternatively referred to as a digital processing unit or microprocessor) and memory 105 communicatively linked to each other by way of a system bus 107. In some embodiments, the electronic computing device 101 can also include one or more other interfaces and/or devices communicatively linked to the system bus 107.

For example, one or more storage devices 109 can be communicatively linked to the system bus 107 by way of one or more storage interfaces 111. One or more display devices 113 can be communicatively linked to the system bus 107 by way of one or more graphics interfaces 115. One or more input devices 117 can be communicatively linked to the system bus 107 by way of one or more input interfaces 119. One or more output devices 121 can be communicatively linked to the system bus 107 by way of one or more output interfaces 123. One or more communication devices 125 can be communicatively linked to the system bus 107 by way of one or more communication interfaces 127.

It should be appreciated that the electronic computing device 101 can have a variety of configurations. For example, in some embodiments, the various components of the electronic computing device 101 can be positioned near each other in one or more housings and on a single circuit board or multiple circuit boards communicatively linked together, or the like. In other embodiments, the various components of the electronic computing device 101 can be located remotely. For example, the one or more input devices 117 and/or the one or more output devices 121 can be located remotely or at a distance from the one or more processors 103 and/or the memory 105.

### Processor

Each of the one or more processors 103 is an electric circuit such as an integrated circuit that executes program instructions. The processor 103 can perform operations such as arithmetic operations, logic operations, controlling operations, and input/output (I/O) operations specified by the program instructions. In some embodiments, the processor 103 includes a control unit (CU), an arithmetic logic unit (ALU), and/or a memory unit (alternatively referred to as cache memory).

The control unit can direct the operation of the processor 103 and/or instruct the memory 105, arithmetic logic unit, and output devices 121 how to respond to instructions in the program. It can also direct the flow of data or information between the processor 103 and other components of the electronic computing device 101. It can also control the operation of other components by providing timing and control signals.

The arithmetic logic unit is an electric circuit in the processor 103 that performs integer arithmetic and bitwise logic operations. The arithmetic logic unit receives input in the form of data or information to be operated on and code describing the operation to be performed. The arithmetic logic unit provides the result of the performed operation as output. In some configurations, the arithmetic logic unit can also include status inputs and/or outputs that convey information about a previous operation or the current operation between the arithmetic logic unit and external status registers.

It should be appreciated that the processor 103 can have any suitable configuration. For example, the processor 103 can range from a simple processor specially built or configured to execute one or more programs for a specific application or device to a complex central processing unit configured to be used in a wide variety of ways and an equally wide variety of applications.

Examples of processors 103 can range from simple controllers to complex computing units. For instance, the processor 103 can be a microcontroller (MCU), a general-purpose central processing unit (CPU) implementing an instruction-set architecture such as ARM, RISC-V, or x86, a digital signal processor (DSP), an application-specific integrated circuit (ASIC), a field-programmable gate array (FPGA), or a more complex system-on-a-chip (SoC) that integrates multiple subsystems (e.g., memory, peripherals, and I/O) onto a single die or chiplet fabric. The processor 103 can be single-core or multi-core and can include specialized co-processors such as a graphics processing unit (GPU), a neural/AI processing unit (NPU), a cryptographic or security engine, a video-encode/decode accelerator, or any combination thereof.

### Memory

The memory 105 (alternatively referred to as primary memory, main memory, or a computer-readable medium) is a semiconductor device or system used to store information for immediate use by the processor 103. The memory 105 is generally directly accessible to the processor 103. The processor 103 can read and execute program instructions stored in the memory 105 as well as store data and/or other information in the memory 105 that is actively being operated on. The memory 105 is generally more expensive and operates at higher speeds compared to the storage device 109. The memory 105 can be volatile such as random-access memory (RAM) or non-volatile such as read-only memory (ROM).

Exemplary memory technologies include static RAM (SRAM), dynamic RAM such as DDR4 or DDR5, low-power DRAM such as LPDDR4 / LPDDR5, and emerging non-volatile memories such as magnetoresistive RAM (MRAM), resistive RAM (ReRAM), or phase-change RAM (PCRAM). In some embodiments, particularly in microcontrollers or SoCs, the memory 105 can be integrated directly with the processor 103 on the same semiconductor die, including types such as SRAM or embedded flash memory.

### System Bus

The system bus 107 broadly refers to the communication system through which information is transferred between the processor 103, the memory 105, and/or other components such as peripherals that can be considered part of the electronic computing device 101. The system bus 107 can include a physical system of connectors, conductive pathways, optical pathways, wires, or the like through which information travels.

The system bus 107 can have a variety of physical configurations. In some embodiments, the system bus can be configured as a backbone connecting the processor 103, the memory 105, and/or the various devices and/or interfaces as shown in the figure. In other embodiments, the system bus 107 can be configured as separate buses that communicatively link one or more components together. For example, the system bus 107 can include a bus communicatively linking the processor 103, the memory 105, and/or a circuit board (the bus can alternatively be referred to as the front-side bus, memory bus, local bus, or host bus). The system bus 107 can include multiple additional I/O buses communicatively linking the various other devices and/or interfaces to the processor 103.

It should be appreciated that information shared between the components of the electronic computing device 101 can include program instructions, data, signals such as control signals, commands, bits, symbols, or the like. The information can be represented using a variety of different technologies and techniques. For example, in some embodiments, the information can be represented by voltages, currents, electromagnetic waves, magnetic fields or particles, optical fields, or the like.

The system bus 107 can also be used for other purposes besides sharing information. For example, the system bus 107 can be used to supply power from the power source 129 to the various devices and/or interfaces connected to the system bus 107. Likewise, the system bus 107 can include address lines which match those of the processor 103. This allows information to be sent to or from specific memory locations in the memory 105. The system bus 107 can also provide a system clock signal to synchronize the various devices and/or interfaces with the rest of the system.

The system bus 107 can use a variety of architectures and protocols depending on the application. For example, in a high-performance computing system, the system bus 107 can implement high-speed peripheral interconnects such as PCI Express (PCIe), Universal Serial Bus (USB), Compute Express Link (CXL), or Thunderbolt. In simpler electronic controllers or within a system-on-a-chip (SoC), the bus architecture can include a network-on-chip (NoC) implementing on-chip communication standards like the advanced microcontroller bus architecture (AMBA, e.g., AXI or CHI) interconnects such as the inter-integrated circuit (I2C) bus, serial peripheral interface (SPI), universal asynchronous receiver-transmitter (UART), or proprietary chiplet interconnects (e.g., Infinity Fabric). For connecting storage devices, architectures can include serial ATA (SATA), universal flash storage (UFS), or NVM express (NVMe) over a PCIe or CXL bus. Interfaces such as HBM, GDDR, or LPDDR5 can be used for high-bandwidth memory subsystems. Protocols such as CAN bus, Modbus, DNP, BACnet, ControlNet, or EtherNet/IP can be used for industrial applications. In some embodiments, the system bus 107 can incorporate wireless or optical interconnects for distributed systems.

### Program Instructions

The instructions stored in the electronic computing device 101 can include software algorithms and/or application programs. It should be appreciated that the software algorithms can be expressed in the form of methods or processes performed in part or entirely by the electronic computing device 101 or as instructions stored in a computer-readable medium such as the memory 105 and/or the storage device 109. Likewise, the software algorithms are shown in the flowcharts and described in the methods and/or processes.

It should be appreciated that instructions can take the form of entirely software (including firmware, resident software, microcode, or the like), entirely hardware, or a combination of software and hardware. If implemented in software executed by the processor 103, the information can be stored on or transmitted over a computer-readable medium such as the memory 105 and/or the storage device 109. In some embodiments, the instructions can be contained in any tangible medium of expression having program code embodied in the medium. In some embodiments, the instructions can be written in any combination of one or more programming languages, which can be text-based or graphical languages.

It should also be appreciated that the flowcharts, block diagrams, methods, and/or processes describe algorithms and/or symbolic representations of information operations. The algorithmic descriptions and representations are the means used by those skilled in the data processing arts to convey the substance of their work most effectively to others skilled in the art. These operations, while described functionally or logically, are understood to be implemented by software and/or hardware that can be readily and easily created from the functional or logical descriptions of the algorithms.

For example, the instructions can include an algorithm for making a decision—e.g., determining whether a parameter satisfies one or more conditions and performing various operations based upon the parameter satisfying the one or more conditions. This can be represented in the instructions with a conditional statement or conditional expression written in a programming language. An example of such a conditional statement or expression is shown below. It should be appreciated that the syntax for the conditional statement or expression will vary depending on the chosen programming language.

if condition1satisfied then

perform operation 1

elseif condition2satisfied then

perform operation 2

elseif condition3satisfied then

perform operation 3

else

perform operation 4;

end if;

The instructions can be used to perform a variety of operations. For example, the instructions can be used to control the receipt and processing of data from the input devices 117. The instructions can also be used to control hardware such as any of the output devices 121.

In some embodiments, the instructions can include firmware 131, which can be a basic input/output system (BIOS), a more modern unified extensible firmware interface (UEFI), or a bootloader. The instructions can further include a hypervisor or virtual-machine monitor, an operating system 133, one or more application programs 135, program data 137, and the like. In simpler embodiments, such as an embedded controller, the instructions can include solely firmware that directly controls the hardware without a separate operating system. In some embodiments, the firmware supports secure boot and over-the-air (OTA) updates to maintain system integrity.

In some embodiments, the instructions and/or program data 137 can include or be generated from a trained machine learning model, such as a neural network, decision tree, or support vector machine. Such models can be configured to process input data and generate outputs for controlling the device or making decisions.

In some embodiments, the instructions are used to control the operation of the lifting assemblies on opposite side walls such as those shown in FIGS. 34. For example, the instructions can be used to control operation of the motor assemblies to keep the beds level or approximately level as they move between the raised position and the lowered position.

### Storage Device

Each of the one or more storage devices 109 (alternatively referred to as secondary memory, or a non-transitory computer-readable medium) is a device or system used to store information that is not needed for immediate use by the processor 103. The storage device 109 can be communicatively linked to the system bus 107 by way of a storage interface 111. The storage device 109 is generally not directly accessible to the processor 103. The storage device 109 is generally less expensive and operates at lower speeds compared to the memory 105. The storage device 109 is also generally non-volatile and used to permanently store the information.

The storage device 109 can take a variety of physical forms and use a variety of storage technologies. For example, in some embodiments, the storage device 109 can be in the form of a hard disk storage device, solid-state storage device, optical storage device, or the like. The storage device 109 can use a variety of storage technologies. For example, storage can be based on semiconductor memory such as flash memory, which is used in solid-state drives (SSDs), embedded MultiMediaCards (eMMC), secure digital (SD) cards and variants (microSD, UHS-II), or USB flash drives. Other technologies include magnetic disks (e.g., hard disk drives), optical discs (e.g., CD, DVD, or Blu-ray), or, for archival purposes, magnetic tape. In some embodiments, the storage device 109 can include or interface with remote or cloud-based storage accessible via a network.

### Display Device

Each of the one or more display devices 113 (alternatively referred to as a human-machine interface (HMI) or screen) is a device that visually conveys text, graphics, video, and/or other information. In some embodiments, the information shown on the display device 113 exists electronically and is displayed for a temporary period of time. It should be appreciated that the display device 113 can operate as an output device and/or input device (e.g., touchscreen display or the like).

The display device 113 can be communicatively linked to the system bus 107 by way of one or more graphics interfaces 115. In some embodiments, the graphics interface 115 can be used to generate a feed of output images to the display device 113. In some embodiments, the graphics interface 115 can be a separate component such as a dedicated graphics card or chip or can be an integrated component that is part of or a subset of the processor 103.

It should be appreciated that the display device 113 can include a variety of physical structures and/or display technologies. For example, in some embodiments, the display device 113 can be a screen integrated into a specific application or technology, a separate screen such as a monitor, or the like. The display device 113 can also be a liquid crystal display, a light emitting diode display, a plasma display, a quantum dot display, or the like.

### Input Devices

Each of the one or more input devices 117 is a physical component that provides information to the processor 103 and/or the memory 105. The input device 117 can be communicatively linked to the system bus 107 by way of one or more input interfaces 119. The input device 117 can be any suitable type and can provide any of a variety of information. For example, the input device 117 can be a digital and/or analog device and can provide information in a digital or analog format. Also, the input device 117 can be used to provide user input for controlling the electronic computing device 101 or operational input for controlling aspects of a specific application.

The input device 117 can include one or more sensors 139 and/or one or more other miscellaneous input devices 141. It should be appreciated that the input device 117 is not limited to only providing information. In some embodiments, the input device 117 can also receive information. Such devices can be considered both an input device 117 and an output device 121.

The miscellaneous input device 141 can include a variety of devices or components. In some embodiments, the miscellaneous input devices 141 can include switches such as limit switches, level switches, vacuum switches, pressure switches, or the like, as well as buttons including pushbuttons or the like. In some embodiments, the miscellaneous input devices 141 include user interface components such as a pointing device, for example a mouse, text input devices, for example a keyboard, a touch screen, or the like.

### Sensors

Each of the one or more sensors 139 can be used to provide information about a wide variety of measured parameters. In general terms, the sensor 139 is used to measure or detect information about its environment and send the information to the processor 103 and/or the memory 105. In some embodiments, the sensor 139 can operate as a transducer and generate an electrical signal as a function of the measured parameter. The electrical signal is communicated to the processor 103 and/or the memory 105 where it can be used for a variety of purposes.

The sensor 139 can be a digital sensor and/or an analog sensor. For example, in some embodiments, the sensor 139 provides digital information to the processor 103 and/or the memory 105. In other embodiments, the sensor 139 provides analog information to the processor 103 and/or the memory 105. Also, in some embodiments, the information can be converted from one type to the other—e.g., from digital to analog or from analog to digital.

The sensor 139 can measure the parameter directly (i.e., direct measurement) or indirectly (i.e., indirect measurement). A direct measurement sensor directly measures the parameter itself. An indirect measurement sensor measures a secondary parameter that can be translated into the parameter of interest.

The sensor 139 can communicate information to the processor 103 and/or the memory 105 in a variety of ways and/or using a variety of protocols. In some embodiments, the sensor 139 can be a protocol-based sensor that uses a protocol to communicate with the processor 103 and/or the memory 105, or it can be a nonprotocol-based sensor that does not use a protocol to communicate with the processor 103 and/or the memory 105. A protocol-based sensor communicates with the processor 103 by sending a data stream by way of a communication protocol. In some embodiments, the protocol-based sensor includes a separate processor that is part of the sensor and used to communicate using the protocol.

It should be appreciated that the information provided by the sensor 139 can be used in a variety of ways by the processor 103. For example, in some embodiments, the processor 103 can compare the information to a setpoint. In some embodiments, analog information is amplified before being compared to the setpoint.

In some embodiments, the sensor 139 can be used to measure one or more parameters. For example, the sensors 139 can be used to measure the position or inclination of one or more of the beds 112, 114. In some embodiments, the sensors 139 can include micro-electro-mechanical systems (MEMS) based sensors. For example, the sensors 139 can include an inertial measurement unit (IMU), which can comprise an accelerometer for detecting linear acceleration and a gyroscope for detecting angular velocity. Other examples include magnetometers for detecting magnetic fields, Global Navigation Satellite System (GNSS) receivers for determining geographic location, and biometric sensors such as fingerprint readers or heart rate monitors. The sensors 139 can also include environmental sensors (e.g., humidity, barometric pressure, gas, smoke, or air-quality), proximity or time-of-flight (ToF) sensors, capacitive touch or force sensors, lidar or radar units for three-dimensional mapping, and biosensors such as ECG, SpO₂, or EEG electrodes.

### Position Sensors

In some embodiments, the sensor 139 is a position sensor configured to measure the position of one or more of the trolleys 122, 124 and/or the position of one or more of the beds 112, 114. The position sensor can be used to determine the absolute or relative position or location of the component or the relative position or displacement of the component in terms of linear travel, rotational angle, or three-dimensional space. In some embodiments, the position sensor acts as a transducer and generates an electrical signal as a function of the measured position.

The position sensor can be a contact type position sensor or a non-contact type position sensor. Contact type position sensors are positioned in physical contact with the component to detect changes in its position. Non-contact type position sensors can detect changes in the position of the component without being in physical contact with it.

The position sensor can be any of a variety of types of position sensors and can be used to measure a variety of positions or movements including linear, rotary, and/or angular positions or movements. For example, suitable position sensors include potentiometric position sensors, inductive position sensors such as a linear variable differential transformer or a rotary variable differential transformer, eddy current-based position sensors, capacitive position sensors, magnetostrictive position sensors, hall effect-based magnetic position sensors, fiber optic position sensors, optical position sensors, ultrasonic position sensors, or the like.

### Level Sensors

In some embodiments, the sensor 139 is a level sensor configured to measure the incline or decline of the beds 112, 114. The level sensor can be used to determine the relative position of the component relative to horizontal. In some embodiments, the level sensor acts as a transducer and generates an electrical signal as a function of the measured position.

The level sensor can be any of a variety of types of level sensors and can be used to measure a variety of positions or movements of the beds 112, 114 or other components of the lifts 100, 200.

### Output Devices

Each of the one or more output devices 121 is a physical component that receives information from the processor 103 and/or the memory 105. The output device 121 can be communicatively linked to the system bus 107 by way of one or more output interfaces 123. The output device 121 can be any suitable type and can receive any of a variety of information. For example, the output device 121 can be a digital and/or analog device and can receive information in a digital and/or analog format. Also, the output device 121 can be used to provide information to the user or perform various operations related to the specific application.

The output device 121 can include one or more actuators 143 and/or one or more other miscellaneous output devices 145. It should be appreciated that the output device 121 is not limited to only receiving information. In some embodiments, the output device 121 can also send information. Such devices can be considered both an output device 121 and an input device 117.

The miscellaneous output devices 145 can include a variety of devices or components. In some embodiments, the miscellaneous output devices 145 can include audio output devices such as speakers as well as other output devices.

### Actuators

Each of the one or more actuators 143 can be used to activate movement or an operation. In general terms, the actuator 143 is used to activate something in response to an instruction or control signal sent from the processor 103. In some embodiments, the actuator 143 can act as a transducer by receiving an electrical signal and transforming it into the desired movement or operation.

The information received by the actuator 143 can take a variety of forms and use a number of technologies. For example, the information can be in the form of an electric voltage or current, pneumatic or hydraulic fluid pressure, binary data, or the like. The information can be provided as digital and/or analog format. For example, in some embodiments, the actuator 143 receives digital information from the processor 103 or other component(s) in the electronic computing device 101. In other embodiments, the actuator 143 receives analog information from the processor 103 or other component(s) in the electronic computing device 101. Also, in some embodiments, the information received by the actuator 143 can be converted from one type to the other—e.g., from digital to analog or from analog to digital.

The actuator 143 can use a variety of energy sources to operate. For example, the actuator 143 can operate using electrical energy, hydraulic energy, pneumatic energy, thermal energy, magnetic energy, or the like. Likewise, the actuator 143 can be an electric actuator, hydraulic actuator, pneumatic actuator, thermal actuator, magnetic actuator, or the like. The actuator 143 can also be used to produce a variety of movements. For example, the actuator 143 can be used to produce linear movement and/or rotary movement.

### Motors

In some embodiments, the actuator 143 can include an electric motor. In general, the electric motor is a device that converts electrical energy to mechanical energy. In some embodiments, the mechanical energy produced by the electric motor is in the form of the rotation of a shaft. The mechanical energy can be used directly or converted into other mechanical movement using levers, gears, ratchets, cams, or the like. The motor can be a DC motor or an AC motor.

### Relays

In some embodiments, the actuator 143 can include a relay. In general, a relay is an electrically operated switch. In some embodiments, the relay includes one or more input terminals to receive information or control signals and one or more operating contact terminals electrically linked to a separate electrical device.

In some embodiments, the relays can include electromechanical relays having contacts that mechanically open and close. For example, the relay can include an electromagnet that opens and closes the contacts. In other embodiments, the relays can include solid state relays that use semiconductor properties to control the on or off state of the relay without any moving parts. Solid state relays can include thyristors and transistors to switch currents up to a hundred amps or more.

### Communication Devices

Each of the communication devices 125 is a physical component that allows the electronic computing device 101 to communicate with other devices, components, and/or networks. The communication device can be communicatively linked to the system bus 107 by way of one or more communication interfaces 127. The communication device 125 can include one or more wired communication devices 147 and/or one or more wireless communication devices 149.

It should be appreciated that the communication device 125 can be any suitable physical device. For example, in some embodiments, the communication device 125 is a network interface controller used to connect the electronic computing device 101 to a larger network such as a local area network (LAN), wide area network (WAN), or the Internet.

It should also be appreciated that the communication device 125 can use a variety of communication protocols. For example, in some embodiments, the wired communication device 147 can use communication protocols such as Ethernet, RS-232, RS-485, USB, industrial real-time Ethernet variants such as EtherCAT or time-sensitive networking (TSN) or the like. Also, in some embodiments, the wireless communication devices 149 can use communication protocols such as Wi-Fi (e.g., 802.11ax, Wi-Fi 6, 802.11be Wi-Fi 7, or Wi-Fi HaLow 802.11ah), Bluetooth (including Bluetooth Low Energy), Zigbee or 802.15.4, Thread and Matter (IoT frameworks), Near Field Communication (NFC), LoRa or Sigfox for long-range low-power links, or cellular standards like LTE, NB-IoT, 5G, or C-V2X.

In some embodiments, the communication devices 125 allow distributed computing, allowing the electronic computing device 101 to offload processing to remote servers or edge devices via cloud services. This can include protocols for Internet of Things (IoT) integration, such as MQTT or CoAP, facilitating real-time data exchange in networked applications.

### Power Source

The power source 129 can be used to supply electric power to the electronic computing device 101. The power source 129 can provide any suitable type of power including AC power, DC power, or the like. The power source 129 can also comprise power-over-ethernet (PoE) injectors, wireless charging coils (e.g., Qi or magnetic-resonant), or supercapacitor banks that supply short-term peak current. The power source 129 can obtain power from any suitable source including an AC power source (standard wall outlet), DC power source (a transformer plugged into a wall outlet), battery, generator, solar panels, or energy-harvesting mechanisms such as kinetic or thermal harvesters.

In some embodiments, the power source 129 includes a power supply that converts electric current from a source to a desired voltage, current, and/or frequency to power the electronic computing device 101. In some embodiments, the power supply can convert AC power ranging from 110–240 VAC to DC power ranging from 6–60 VDC and can support low-power modes for energy-efficient operation in embedded systems.

In some embodiments, the electronic computing device 101 includes a dedicated power management unit (PMU), which can be a separate chip or integrated into the processor 103. The PMU can manage power rails, battery charging, and transitions between various power states, such as active, idle, sleep, or deep-sleep modes, to optimize power consumption. This allows for energy-efficient operation, particularly in battery-powered or energy-harvesting applications.

### Circuit Board

The electronic computing device 101 can include one or more circuit boards (alternatively referred to as logic boards) to which one or more of the components can be coupled. For example, the processor 103, the memory 105, the storage device 109, the display device 113, the input device 117, the output device 121, the communication device 125, and/or the power source 129 can be coupled to one or more circuit boards. In some embodiments, the processor 103, the memory 105, and/or the storage device 109 can be coupled to one circuit board.

In some embodiments, the circuit board can contain a series of conductive tracks, pads, and/or other features etched from one or more sheet layers of copper laminate laminated onto and/or between sheet layers of nonconductive substrate. The conductive features can be part of the system bus 107 communicatively linking the various components of the electronic computing device 101. In some embodiments, the circuit board can be a printed circuit board. In some embodiments, the circuit board can be a motherboard.

### General Terminology and Interpretative Conventions

The articles “the,” “a,” and “an” shall be interpreted as referring to both singular and plural forms. Additionally, unless preceded by the word “either” or similar language indicating exclusivity, the term “or” should be interpreted inclusively (for example, “x or y” refers to one or both x and y).

The term “and/or” shall be interpreted inclusively; for example, “x and/or y” refers to either x, y, or both. When “and/or” or “or” is used to connect three or more items, the phrase shall be interpreted to encompass any individual item, all items collectively, or any combination of the items.

The phrase “based on” shall be interpreted to mean an open set of conditions unless it is explicitly limited (for example, based on only a given condition). For instance, if a step is described as being based on a particular condition, it may depend on both the stated condition and additional unstated conditions.

The term “can,” when used as an auxiliary verb, indicates that the described subject matter optionally has the feature, aspect, ability, capacity, or the like, but it is not required in any given instance.

The terms "have," "having," "contain," "containing," "include," "including," and "characterized by" shall be construed as synonymous with "comprise" and "comprising"—that is, these terms are inclusive or open-ended and do not preclude additional, unrecited subject matter. The use of these terms shall also be interpreted as providing disclosure and support for narrower alternative embodiments in which these terms are substituted with "consisting of," "consisting of the recited subject matter plus impurities and/or trace amounts of other materials," or "consisting essentially of."

It shall be understood that features described in separate embodiments can be combined as a single embodiment. Similarly, features described together in a single embodiment can be implemented separately or in various subcombinations across multiple embodiments. Additionally, although certain features may be initially presented or claimed as part of specific combinations, it is possible to remove one or more features from a claimed combination so that the claim pertains to a subcombination or a variation thereof.

Numerous aspects or features are described as optional, often indicated by terms such as "can" or similar expressions. This document does not detail every possible combination or permutation arising from selecting among these optional elements. Nevertheless, all such combinations and permutations are considered expressly disclosed herein. For instance, an item described with three optional aspects may be embodied in seven distinct configurations: any single aspect, any pair of aspects, or all three aspects incorporated together.

The methods described in this document shall not be interpreted to require steps to be performed in a particular order unless explicitly indicated or if it is impossible to do otherwise. The methods should be understood to provide support or basis for the steps to be carried out in any sequence.

The configurations presented in this document are provided as examples and do not encompass all possible implementations within the scope of the claims. The term “example” is used to indicate an instance or illustration, without implying that it is preferred or superior to other possibilities.

Unless otherwise indicated, all numerical values or expressions regarding dimensions, physical characteristics, or similar parameters in the specification (excluding the claims) shall be interpreted as qualified by the term “approximately.” Additionally, if there is an absence of functional, qualitative, or other interpretative guidelines, each numerical value identified as "approximately" within the specification and claims shall be interpreted based on the stated number of significant digits and/or standard rounding conventions, without limiting the application of the doctrine of equivalents to the claims.

All disclosed ranges shall be interpreted as encompassing, and providing support for, claims that specify any subranges or individual values contained within each stated range. For instance, if a range is described as 1 to 10, it is intended to include and support claims directed to all subranges and individual values falling between, and including, the minimum value of 1 and the maximum value of 10. This includes all subranges commencing at a value of 1 or higher and concluding at a value of 10 or lower (e.g., 5.5 to 10, 2.34 to 3.56), as well as any individual values from 1 to 10 (e.g., 3, 5.8, 9.9994). The values in the range may be recited independently, as a minimum value (e.g., at least 5.8), or as a maximum value (e.g., no more than 9.9994).

All disclosed numerical values shall be interpreted as variable within a range of 0–100% in either direction. This interpretation provides support for claims referencing these values, whether stated individually or as a minimum or maximum (e.g., at least <value> or no more than <value>), as well as any ranges or subranges that can be derived from such values. For instance, a specified value of 8 should be considered as extending from 0–16 (reflecting 100% variability in both directions) and supports claims referring to the entire range (e.g., 0–16), any subrange within this interval (e.g., 2–12.5), or any individual value within the range (e.g., 15.2), including its use as a minimum value (e.g., at least 4.3) or a maximum value (e.g., no more than 12.4).

The terms in the claims shall be interpreted according to their ordinary and customary meanings, as established by relevant entries in widely recognized general or technical dictionaries and by commonly accepted meanings within the pertinent field. The interpretation should reflect the broadest meaning derived from any single source or from a combination of these sources (e.g., by synthesizing multiple dictionary definitions to arrive at the most comprehensive understanding), except under the following circumstances: (a) if a term is employed in a manner that extends beyond its ordinary usage, it should be accorded its customary meaning along with the broader meaning or (b) if a term is expressly defined within the document by language such as “as used in this document <term> shall mean,” “this term means,” “this term is defined as,” or “for the purposes of this disclosure this term shall mean.” References to specific examples, use of “i.e.,” or use of the word “invention” are not intended to invoke exception (b) or to otherwise narrow the scope of the claim terms. Except where exception (b) applies, nothing in this document should be construed as a disclaimer or limitation of claim scope.

The limitations in the claims shall not be interpreted as invoking 35 U.S.C. 112(f) unless the claim specifically includes the terms “means for” or “step for.”

Unless otherwise specified or clearly indicated by the context, terms such as “processing,” “computing,” “calculating,” “determining,” and “displaying” refer to actions and operations performed by an electronic computing device that includes a processor and memory.

The subject matter recited in the claims is not coextensive with and should not be interpreted as coextensive with any embodiment, feature, or combination of features described or illustrated in this document. This is the case even if only one version of a feature or combination is depicted and discussed.

### Joining or Fastening Terminology and Interpretative Conventions

The term “coupled” means the joining of two members directly or indirectly to one another. Such joining can be stationary in nature or movable in nature. Such joining can be achieved with the two members or the two members and any additional intermediate members being integrally formed as a single unitary body with one another or with the two members or the two members and any additional intermediate member being attached to one another. Such joining can be permanent in nature or alternatively can be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Quickly releasable joining (i.e., quick-release) refers to joining that can be released without the use of tools. Readily or easily releasable joining refers to joining that can be readily, easily, and/or promptly released with little or no difficulty or effort. Some joining can qualify as both quickly releasable joining and readily or easily releasable joining. Other joining can qualify as one of these types of joining but not the other. For example, one type of joining can be readily or easily releasable but also require the use of a tool.

Non-quickly releasable joining (i.e., non-quick-release) refers to joining that can only be released with the use of tools. Difficult or hard to release joining refers to joining that is difficult, hard, or arduous to release and/or requires substantial effort to release. Some joining can qualify as both non-quickly releasable joining and difficult or hard to release joining. Other joining can qualify as one of these types of joining but not the other. For example, one type of joining can require the use of a tool but may not be difficult or hard to release.

The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners is given below. The list is divided according to whether the fastening method and/or fastener is generally permanent, readily released, or difficult to release. A general reference to fastening or fasteners without specifying a particular fastening method(s) or fastener(s) should be interpreted as including any type of fastening method and/or fastener.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pins, linchpins, R-pins, clevis fasteners, cotter pins, latches, hook and loop fasteners (VELCRO), hook and eye fasteners, push pins, clips, clasps, clamps, zip ties, zippers, buttons, buckles, and/or confirmat fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, or the like can be permanent, readily releasable, or difficult to release depending on the application.

### Drawing Related Terminology and Interpretative Conventions

Reference numbers in the drawings and corresponding description refer to identical or similar elements although such numbers can be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0–100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter can assume various alternative orientations and, accordingly, such terms are not to be considered as limiting.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Benefit/priority patent documents incorporated by reference:

U.S. Prov. App. No. 63/745,142, titled “Bed Lift Systems,” filed on 14 Jan 2025.

Additional documents incorporated by reference:

U.S. Pat. Pub. No. 2013/0081336 (App. No. 13/685,471), titled “Bed Lift,” filed on 26 Nov 2012, published on 4 Apr 2013.

U.S. Pat. Pub. No. 2015/0329035 (App. No. 14/714,215), titled “Bed Lift Mounting Member,” filed on 15 May 2015, published on 19 Nov 2015.

U.S. Pat. Pub. No. 2018/0027978 (App. No. 15/660,938), titled “Furniture Lifting System,” filed on 26 Jul 2017, published on 1 Feb 2018.

U.S. Pat. Pub. No. 2019/0217752 (App. No. 16/247,536), titled “Bed Support Mechanism for a Bed Lift,” filed on 14 Jan 2019, published on 18 Jul 2019.

U.S. Pat. App. No. 17/451,640, titled “Bed Lifts and Related Structures,” filed on 20 Oct 2021.

U.S. Pat. Pub. No. 2022/0242300 (App. No. 17/659,591), titled “Bed Lift Mounting Member,” filed on 18 Apr 2022, published on 4 Aug 2022.

U.S. Pat. Pub. No. 2024/0278708 (App. No. 18/582,605), titled “Lifts for Recreational Vehicles and Other Structures,” filed on 20 Feb 2024, published on 22 Aug 2024.

1. A lift comprising:
a guide rail having a lengthwise direction, the guide rail being structured to be coupled to a wall of a structure in a vertical orientation;
a pulley coupled to the guide rail; and
a belt coupled to and extending along the guide rail in the lengthwise direction, the belt wrapping around the pulley;
wherein the pulley is positioned to rotate about an axis that is parallel to the wall of the structure.

2. The lift of claim 1 comprising a pulley housing having an interior surface that guides a flat side of the belt, wherein the pulley is positioned within the pulley housing.

3. The lift of claim 2 wherein the pulley comprises a double pulley positioned in the pulley housing.

4. The lift of claim 1 wherein the guide rail comprises an aluminum extrusion.

5. The lift of claim 1 wherein the pulley is positioned at a top end of the guide rail.

6. The lift of claim 1 comprising a trolley coupled to the belt and movable along the guide rail in the lengthwise direction.

7. The lift of claim 6 wherein the trolley comprises:
a main body including a cavity, a wall, and a slot in the wall;
a hanger bracket positioned in the cavity and extending outward from the main body through the slot in the wall; and
an insert positioned in the cavity.

8. The lift of claim 7 wherein the hanger bracket is positioned between the wall of the main body and the insert.

9. The lift of claim 6 comprising a belt attachment bracket coupling the trolley to the belt.

10. The lift of claim 1 comprising an electric motor structured to drive the belt.

11. The lift of claim 1 wherein the guide rail is a first guide rail, the pulley is a first pulley, and the belt is a first belt, the lift comprising:
a second guide rail;
a second pulley coupled to the second guide rail; and
a second belt coupled to and extending along the second guide rail, the second belt wrapping around the second pulley;
wherein the second pulley is positioned to rotate about a second axis that is parallel to the wall.

12. The lift of claim 1 wherein the structure comprises a recreational vehicle and/or a cargo trailer.

13. The lift of claim 1 wherein the guide rail is positioned in the wall of the structure.

14. A lift comprising:
a guide rail having a lengthwise direction, the guide rail being structured to be coupled to a structure in a vertical orientation;
a belt coupled to and extending along the guide rail in the lengthwise direction;
a trolley coupled to the guide rail, the trolley being movable along the guide rail in the lengthwise direction; and
a belt attachment bracket coupled to the belt and positioned to support the trolley as it moves along the guide rail in the lengthwise direction, the belt attachment bracket comprising:
a belt clamp coupled to the belt; and
a housing coupled to the belt clamp and structured to maintain engagement between the belt clamp and the belt.

15. The lift of claim 14 wherein the housing is coupled to the belt clamp by fasteners at a bottom end of the housing.

16. The lift of claim 14 wherein the belt attachment bracket extends underneath and contacts the trolley.

17. The lift of claim 14 comprising a furniture item supported by the trolley, the furniture item comprising a bed and/or a sofa.

18. The lift of claim 17 comprising:
a support leg coupled to the furniture item, the support leg being structured to move between a stowed position and a deployed position; and
an activation mechanism structured to engage the guide rail and cause the support leg to move from the stowed position to the deployed position.

19. The lift of claim 18 wherein the activation mechanism comprises a trigger stop on the guide rail and a tab on the support leg.

20. A lift comprising:
a guide rail having a lengthwise direction, the guide rail being structured to be coupled to a structure in a vertical orientation;
a trolley coupled to the guide rail, the trolley being movable along the guide rail in the lengthwise direction;
a mounting bracket coupled to the trolley and structured to support a furniture item as the trolley moves along the guide rail in the lengthwise direction;
a support leg coupled to the mounting bracket, the support leg being structured to move between a stowed position and a deployed position; and
an activation mechanism coupled to the mounting bracket;
wherein the activation mechanism is structured to engage the guide rail and cause the support leg to move from the stowed position to the deployed position.
